(19) United States
(12) Patent Application Publication
(10) Pub. No.: US 2005/0102154 A1
(43) Pub. Date: May 12, 2005

(54) Method, computer useable medium, and system for enterprise resource management

(76) Inventors: Ryan A. Dodd, Bear, DE (US); Russell H. Dodd, Middletown, DE (US); D. Stephen Wooters, Woodbridge, CT (US)

Correspondence Address: Richard C. Litman;LITMAN LAW OFFICES, LTD., P.O. Box 15035, Arlington, VA, 22215, US

(21) Appl. No.: 10/705,535

(22) Filed: Nov. 12, 2003

(51) Int. Cl. G06F 17/60

(52) U.S. Cl. 705/1; 705/8

(57) ABSTRACT

A method, computer useable medium, and/or system for ERM that executes ERM software for managing internal resources of a company/business in an ERM system, selectively authorizes users associated with the company/business based on grouping designations of the users to access internal resource data about the company/business via the ERM software and an ERM database, and manages, distributes, tracks, organizes, analyzes, and stores internal resource data via the ERM software.

### BACKGROUND OF THE INVENTION

1. Field of the Invention

The present invention relates generally to management systems and, more particularly to a method, computer useable medium, and/or system for enterprise resource management.

2. Description of the Related Art

Many companies and/or businesses invest a sizable amount of revenue in providing entertainment to clients, vendors, employees, etc. Currently, such companies and/or businesses utilize rudimentary processes to manage, distribute, track, organize, analyze, and store their entertainment assets (e.g., tickets, coupons, raffles, etc.). There is a need for a method, computer useable medium, and/or system that is configured to enable a company and/or business to easily control and manage every aspect of their internal resources. The related art is represented by the following references of interest.

U.S. patent application Publication No. 2002/0042729 A1, published on Apr. 11, 2002 for Shunsuke Yajima et al., describes a specific electronic information related information providing system and method for providing information related to specific electronic information to a holder of the specific electronic information. The Yajima et al. application does not suggest a method, computer useable medium, and/or system for enterprise resource management according to the claimed invention.

U.S. patent application Publication No. 2002/0077983 A1, published on Jun. 20, 2002 for Nobuhiro Tagashira, describes a ticket management system for issuing electronic tickets and distributing paper tickets of paper media on which electronic tickets were output, to a ticket issuance apparatus and a ticket input apparatus constituting the ticket management system, to its control method, and to a computer readable storage medium storing programs for realizing the functions of the method. The Tagashira application does not suggest a method, computer useable medium, and/or system for enterprise resource management according to the claimed invention.

U.S. patent application Publication No. 2002/0082879 A1, published on Jun. 27, 2002 for Brent Miller et al., describes a method and system for seat selection and ticket purchasing in a networked computer system. The Miller et al. application does not suggest a method, computer useable medium, and/or system for enterprise resource management according to the claimed invention.

U.S. patent application Publication No. 2002/0116234 A1, published on Aug. 22, 2002 for Mikio Nagasawa, describes a method for providing information service and for managing information processing resources. The Nagasawa application does not suggest a method, computer useable medium, and/or system for enterprise resource management according to the claimed invention.

U.S. patent application Publication No. 2002/0116343 A1 and Japan patent application Publication No. 2002197221 A, published on Aug. 22, 2002 and Jul. 12, 2002, respectively, for Masakazu Nakamura et al., describe an apparatus, system, and method for electronic ticket management and electronic ticket distribution authentication. The Nakamura et al. applications do not suggest a method, computer useable medium, and/or system for enterprise resource management according to the claimed invention.

U.S. patent application Publication No. 2002/0174003 A1, published on Nov. 21, 2002 for William G. Redmann et al., describes a method and apparatus for providing visitors with a personalized itinerary and managed access to attractions. The Redmann et al. application does not suggest a method, computer useable medium, and/or system for enterprise resource management according to the claimed invention.

U.S. Pat. No. 4,931,932, issued on Jun. 5, 1990 to Stanley Dalnekoff et al., describes a computerized system with means to automatically clear and sell wait-listed customer reservations. The Dalnekoff et al. patent does not suggest a method, computer useable medium, and/or system for enterprise resource management according to the claimed invention.

U.S. Pat. No. 5,404,291, issued on Apr. 4, 1995 to Gordon S. Kerr et al., describes an inventory control system for allocating items of inventory in an optimal manner. The Kerr et al. patent does not suggest a method, computer useable medium, and/or system for enterprise resource management according to the claimed invention.

U.S. Pat. No. 5,581,461, issued on Dec. 3, 1996 to Denise Coll et al., describes a computerized system and method for storage, processing, and transfer of inventory and other data among a central processor/database and a number of remote locations. The Coll et al. patent does not suggest a method, computer useable medium, and/or system for enterprise resource management according to the claimed invention.

U.S. Pat. No. 6,014,628, issued on Jan. 11, 2000 to Vincent J. Kovarik, Jr., describes a method and system for generically tracking an entity in a specific domain. The Kovarik, Jr. patent does not suggest a method, computer useable medium, and/or system for enterprise resource management according to the claimed invention.

U.S. Pat. No. 6,067,532, issued on May 23, 2000 to Lucas Gebb, describes a method and system for redistributing, purchasing, or selling tickets oh the secondary market. The Gebb patent and application does not suggest a method, computer useable medium, and/or system for enterprise resource management according to the claimed invention.

U.S. Pat. No. 6,356,874 B1, issued on Mar. 12, 1992 to Harald Øhrn, describes a computer-based method and system for ordering services. The Øhrn patent does not suggest a method, computer useable medium, and/or system for enterprise resource management according to the claimed invention.

U.S. Pat. No. 6,477,533 B2, issued on Nov. 22, 2002 to Martin E. Schiff et al., describes a method and system for managing agent ownership of customers utilizing a cruise web server environment to electronically communicate via a data communications network with a plurality of remote users using web browser programs. The Schiff et al. patent does not suggest a method, computer useable medium, and/or system for enterprise resource management according to the claimed invention.

Europe Published patent application No. EP 1,098,273 A2, published on May 9, 2001, describes an electronic ticket selling system. The Europe '273 application does not suggest a method, computer useable medium, and/or system for enterprise resource management according to the claimed invention.

World Intellectual Property Organization (WIPO) Patent Application Publication No. WO 01/71669 A2, published on Sep. 27, 2001, describes an electronic ticket exchange system that enables venue owners to sell tickets to patrons at a fair market value for each event, and patrons to more easily trade and transfer tickets among one another after they have been purchased from the venue owner. The WIPO '669 application does not suggest a method, computer useable medium, and/or system for enterprise resource management according to the claimed invention.

WIPO patent application Publication No. WO 01/95158 A1, published on Dec. 13, 2001, describes a method and apparatus for managing and accessing information related to a computerized system. The WIPO '158 application does not suggest a method, computer useable medium, and/or system for enterprise resource management according to the claimed invention.

Japan patent application Publication No. 2002140401 A, published on May 17, 2002, describes a seat reservation and selling system and a ticket selling management system of a reserving company capable of smoothly managing two kinds of change and refund procedures before and after the issue of tickets, and allowing a ticket issuing store to acquire conventional sales and dealing percentage income. The Japan '401 application does not suggest a method, computer useable medium, and/or system for enterprise resource management according to the claimed invention.

Japan patent application Publication No. 2002183766 A, published on Jun. 28, 2002, describes a management method and device for ticket issue. The Japan '766 application does not suggest a method, computer useable medium, and/or system for enterprise resource management according to the claimed invention.

Japan patent application Publication No. 2002203161 A, published on Jul. 19, 2002, describes an electronic ticket issue management system and usage management system for carrying out a sales procedure from booking to issue of a ticklet via the internet for issuing an electronic ticket to a customer. The Japan '161 application does not suggest a method, computer useable medium, and/or system for enterprise resource management according to the claimed invention.

Japan patent application Publication No. 2002269279 A, published on Sep. 20, 2002, describes a transfer management method for an on-line ticket and management server system that reduces management cost by facilitating ticket management including ticket transfer confirmation without directly selling the ticket. The Japan '279 application does not suggest a method, computer useable medium, and/or system for enterprise resource management according to the claimed invention.

WIPO patent application Publication No. WO 02/075626 A1, published on Sep. 26, 2002, describes an on-line ticket transaction system and method. The WIPO '626 application does not suggest a method, computer useable medium, and/or system for enterprise resource management according to the claimed invention.

WIPO patent application Publication No. WO 02/080068 A1, published on Oct. 10, 2002, describes a ticket issuing, home delivering system. The WIPO '068 application does not suggest a method, computer useable medium, and/or system for enterprise resource management according to the claimed invention.

WIPO patent application Publication No. WO 02/086789 A1, published on Oct. 31, 2002, describes a method for conducting an on-line raffle session. The WIPO '789 application does not suggest a method, computer useable medium, and/or system for enterprise resource management according to the claimed invention.

Europe patent application Publication No. EP 1 267 289 A1, published on Dec. 18, 2002, describes an electronic ticket system in which right information on a ticket is purchased via communication means, and a writable storage medium of the right information is used, thereby granting admittance into an event facility. The Europe '289 application does not suggest a method, computer useable medium, and/or system for enterprise resource management according to the claimed invention.

None of the above inventions and patents, taken either singly or in combination, is seen to describe the instant invention as claimed. Thus, a method, computer useable medium, and/or system for enterprise resource management solving the aforementioned problems is desired.

### SUMMARY OF THE INVENTION

The present invention is a method, computer useable medium, and/or system for enterprise resource management (ERM) that executes ERM software for managing internal resources of a company/business in an ERM system, selectively authorizes users associated with the company/business based on grouping designations of the users to access internal resource data about the company/business via the ERM software and an ERM database, and manages, distributes, tracks, organizes, analyzes, and stores internal resource data via the ERM software.

Accordingly, it is a principal aspect of the invention to provide a method, computer useable medium, and/or system for ERM that executes ERM software for managing internal resources of a company/business in an ERM system, selectively authorizes users associated with the company/business based on grouping designations of the users to access internal resource data about the company/business via the ERM software and an ERM database, and manages, distributes, tracks, organizes, analyzes, and stores internal resource data via the ERM software.

It is another aspect of the invention to provide a method, computer useable medium, and/or system for ERM that executes a users administrative interface portion of the ERM software; executes an inventory portion of the ERM software, executes a distribution portion of the ERM software, executes a maintenance information portion of the ERM software, executes a maintenance and support portion of the ERM software, executes a communication portion of the ERM software, executes a help and tutorial portion of the ERM software, executes a user information and system settings portion of the ERM software, selectively authorizes users associated with the company/business based on grouping designations of the users to access internal resource data about the company/business via the ERM software and an ERM database, and manages, distributes, tracks, organizes, analyzes, and stores internal resource data via the ERM software.

It is a further aspect of the invention to provide a method, computer useable medium, and/or system for ERM that executes ERM software for managing internal resources of a company/business in an ERM system, selectively authorizes users associated with the company/business based on grouping designations of the users to access internal resource data about the company/business via the ERM software and an ERM database, and manages, distributes, tracks, organizes, analyzes, and stores internal resource data via the ERM software, and analyzes entertainment resources stored in the ERM database by utilizing information from a national event index service.

It is an aspect of the invention to provide improved elements and arrangements thereof in a method, computer useable medium, and/or a system for enterprise resource management for the purposes described which is dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a functional diagram of a system for enterprise resource management according to the present invention.

FIG. 2 is a functional diagram of portions of ERM software that are accessible to an interconnected computer according to the present invention.

FIG. 3 is a functional diagram of a login portion of ERM software according to the present invention.

FIGS. 4A and 4B are a functional diagram of a user administrative portion of ERM software according to the present invention.

FIG. 5 is a functional diagram of an inventory portion of ERM software according to the present invention.

FIG. 6 is a functional diagram of a distribution portion of ERM software according to the present invention.

FIG. 7 is a functional diagram of a management information systems portion of ERM software according to the present invention.

FIG. 8 is a functional diagram of a maintenance and support portion of ERM software according to the present invention.

FIG. 9 is a functional diagram of a communication portion of ERM software according to the present invention.

FIG. 10 is a functional diagram of a help and tutorial portion of ERM software according to the present invention.

FIG. 11 is a functional diagram of a software user interface portion of ERM software according to the present invention.

FIG. 12 is a functional diagram of site administrator processes that may occur during interaction with ERM software according to the present invention.

FIG. 13 is a functional diagram of site assistant administrator processes that may occur during interaction with ERM software according to the present invention.

FIG. 14 is a functional diagram of item manager processes that may occur during interaction with ERM software according to the present invention.

FIG. 15 is a functional diagram of general user processes that may occur during interaction with ERM software according to the present invention.

FIG. 16 is a functional diagram of inventory manager processes that may occur during interaction with ERM software according to the present invention.

FIG. 17 is a functional diagram of reporting manager processes that may occur during interaction with ERM software according to the present invention.

FIG. 18 is a functional diagram of distribution manager processes that may occur during interaction with ERM software according to the present invention.

FIG. 19 is a functional diagram of human resource manager processes that may occur during interaction with ERM software according to the present invention.

FIG. 20 is a diagram of the tables included in an ERM database according to the present invention.

FIGS. 21A, 21B, 21C, and 21D are table structures of an ERM database according to the present invention.

FIGS. 22A, 22B, 22C, and 22D are table structures of an ERM database according to the present invention.

FIG. 23 is a functional diagram of ERM database table relationships between primary keys and foreign keys that may occur during interaction with ERM software according to the present invention.

FIG. 24 is table structures of a National Event Index Service (NEIS) database according to the present invention.

FIG. 25 is a functional diagram of database table relationships within the NEIS structure that may occur during interaction with ERM software according to the present invention.

FIG. 26 is a basic XML structure for a Hyper Text Transport Protocol (HTTP) request and response from the NEIS system according to the present invention.

FIGS. 27A, 27B, and 27C are a basic XML structure for a HTTP request and response from the NEIS system that may be used with ERM software according to the present invention.

Similar reference characters denote corresponding features consistently throughout the attached drawings.

### DETAILED DESCRIPTION OF THE PREFERRED EMBODIMENTS

The present invention is a method, computer useable medium, and/or system for enterprise resource management. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

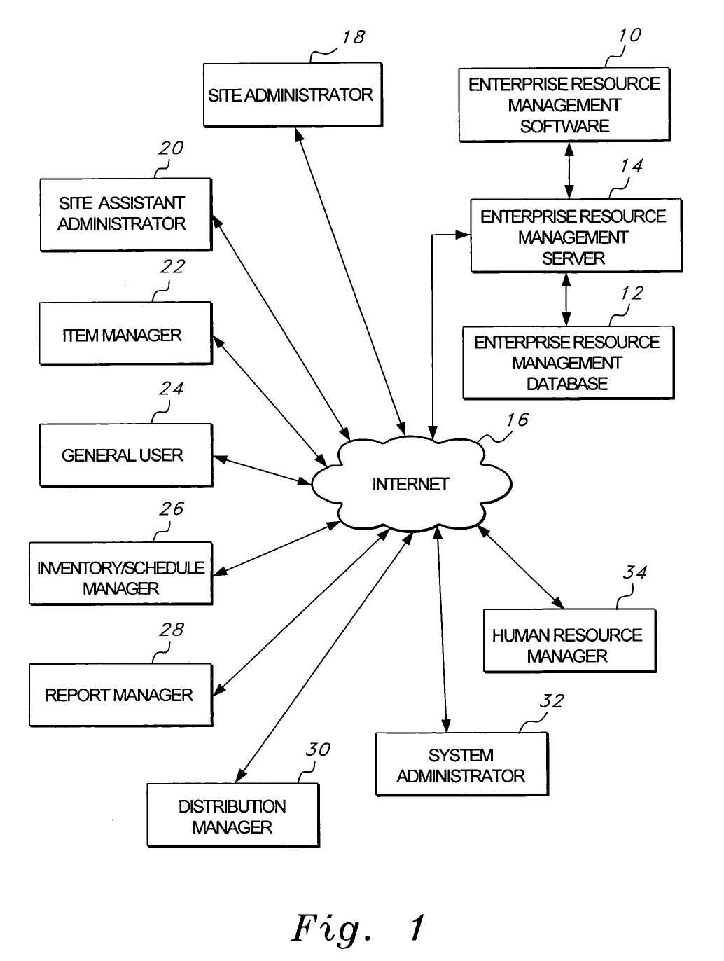

Referring to the drawings, FIG. 1 shows an ERM system where a variety of users may interconnect with an ERM website over the Internet 16. The ERM website is administered by an ERM database 12 and an ERM server 14. The ERM system is configured to enable a company and/or business to manage, distribute, track, organize, analyze, and store their internal resources, such as entertainment assets or the like, with ease and simplicity.

The ERM server 14 includes stored therein ERM software 10. The ERM software 10 may be stored in the memory of the server 14 that may be any combination of random access memory or cache memory. The ERM software 10 includes a plurality of computer instructions and may additionally be carried on any computer useable medium according to the desires of the user, such as a computer hard drive, a floppy disk, Flash memory, optical memory, magnetic media memory, or the like. The ERM server 14 includes a processor, an operating system, application programs, and data. In accordance with well known principles, the processor executes the applications in the memory of the ERM server 14 under control of the operating system.

A variety of users may use the ERM system. The variety of users who may use the ERM system may be categorized into groups of users including a SITE ADMINISTRATOR 18, a SITE ASSISTANT ADMINISTRATOR 20, an ITEM MANAGER 22, a GENERAL USER 24, an INVENTORY/SCHEDULE MANAGER 26, a REPORT MANAGER 28, a DISTRIBUTION MANAGER 30, a SYSTEM ADMINISTRATOR 32, and a HUMAN RESOURCE MANAGER 34.

Any of the users 18, 20, 22, 24, 26, 28, 30, 32, and 34 may utilize a computer device to wirelessly and/or non-wirelessly interconnect with the ERM website 10. Such a computer device may be a wireless or non-wireless palm-top, lap-top, personal computer, workstation, or any other similar configured computer device. The computer device may execute standard operating system software, such as Windows 98, 2000, XP, UNIX, or the like.

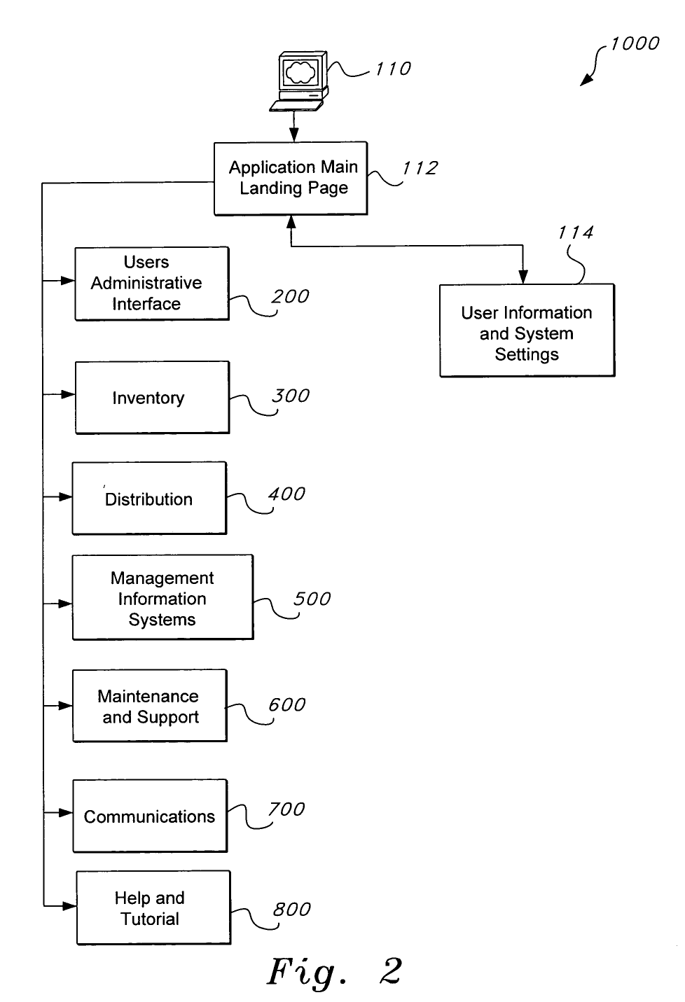

FIG. 2 shows portions 1000 of the ERM software 10 that are accessible to a user using an interconnected computer 110. Users administrative interface 200, inventory 300, distribution 400, maintenance information 500, maintenance and support 600, communication 700, and help and tutorial 800 portions of the ERM software 10 are available to a user using an interconnected computer 110 via a MAIN LANDING page 112. The user may also modify and/or change user information and system settings using the user information and system settings 114 portion of the ERM software 10.

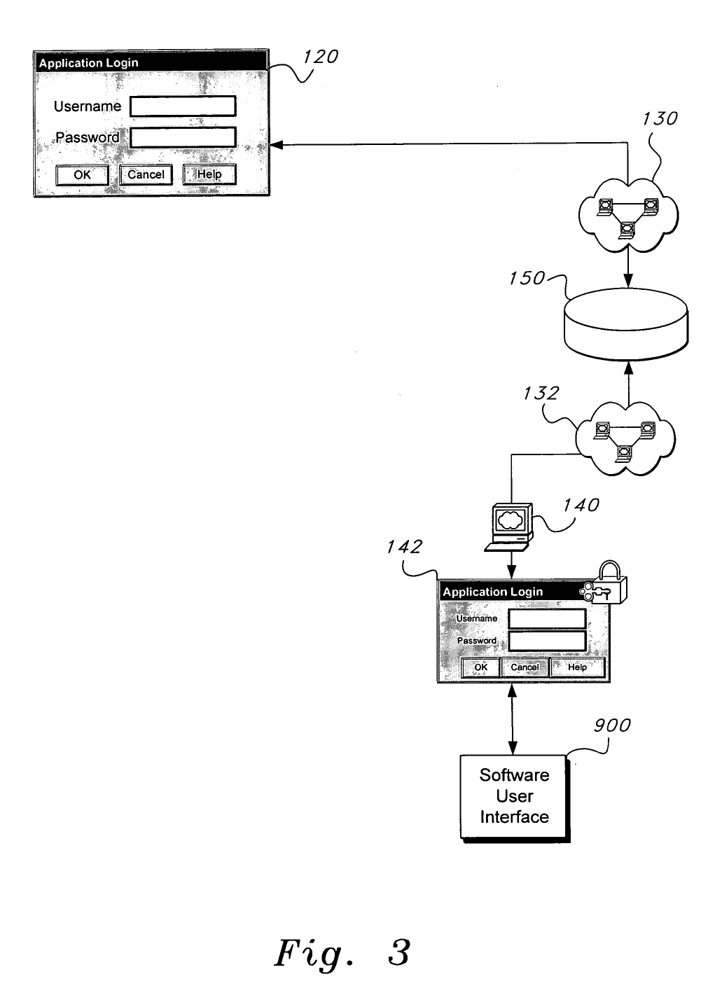

FIG. 3 shows the login portion of the ERM software 110. The LOGIN page 120 is the gateway to the administrative tools for the ERM software 10 and the ERM database 150. The LOGIN page 120 requires a user to enter a username and password. Any administrative user may login through this path and access their job functions as specified by their user group. A user who desires to access the SOFTWARE USER INTERFACE page 900 may be required to enter a user and password using a SECURE LOGIN page 142. Successful access past the LOGIN page 120 enables a user to access the MAIN LANDING page 112 where every administrative function in the ERM software may be accessed.

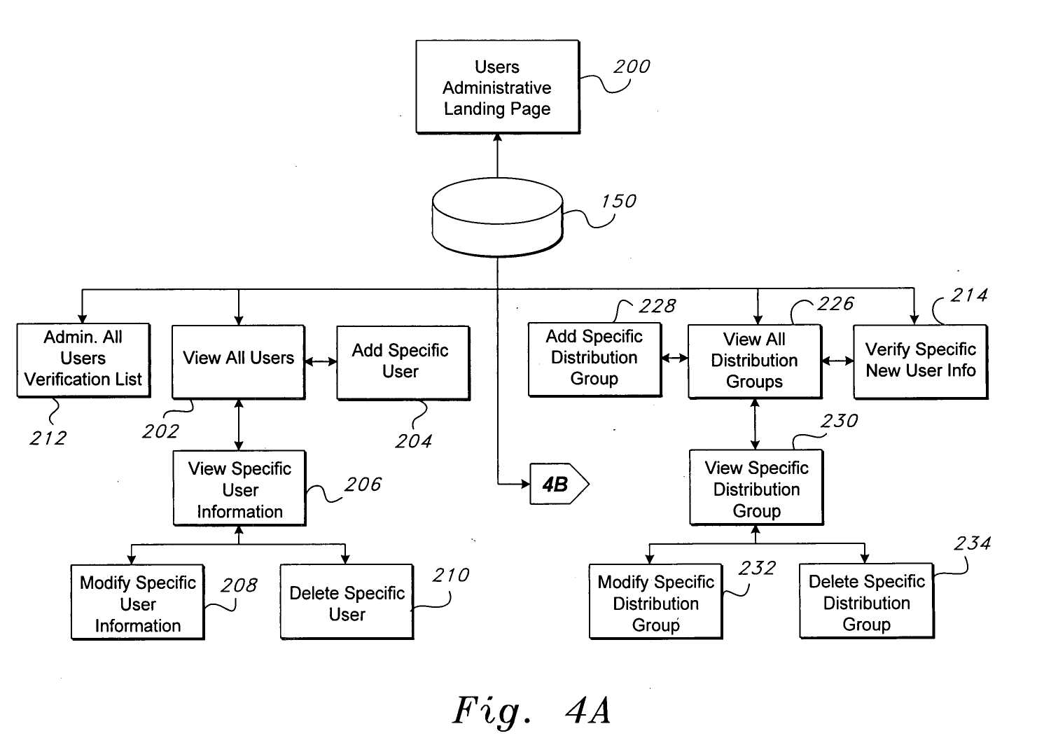

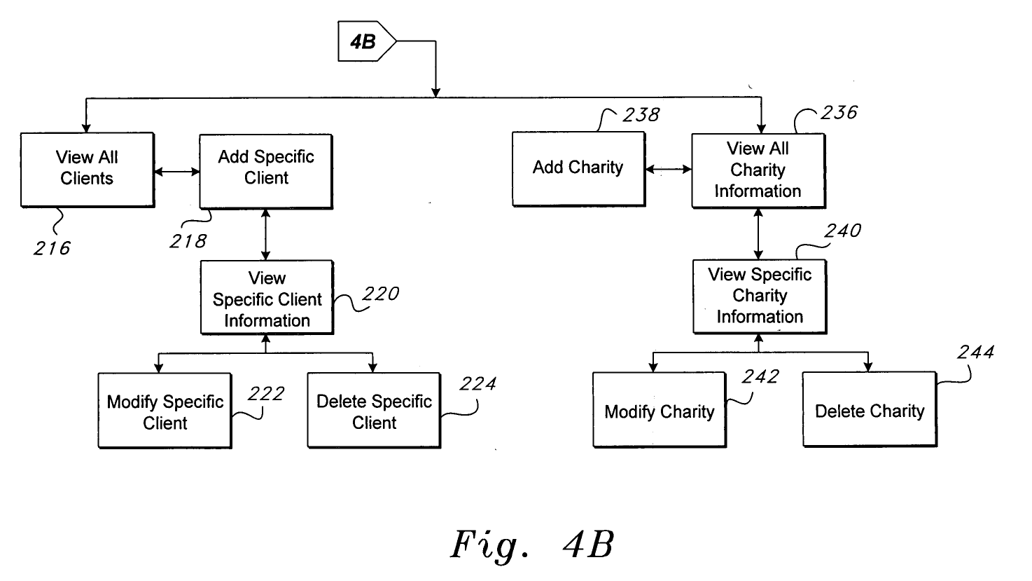

FIGS. 4A and 4B show user administrative processes available to a user after accessing the USERS ADMINISTRATIVE INTERFACE LANDING page 200. The USERS ADMINISTRATIVE INTERFACE LANDING page 200 enables a user to view all of the users inside the ERM database 150 via the VIEW ALL USERS page 202. The ERM software 10 provides a list of the users that may be sorted by various fields. From the list a particular user may choose to view the information associated with his/her or any other user's entire profile that is contained within the ERM database 150.

The ADD SPECIFIC USER page 204 enables a user to manually add a new user into the ERM database 150 by entering a multitude of information that may include name, address, contact information, username, password, working group, or the like. When all desired information has been entered the new user is then added to the ERM database 150. The VIEW SPECIFIC USER INFORMATION page 206 displays an entire user profile including the full name, email address, contact information, username, or the like.

The MODIFY SPECIFIC USER INFORMATION page 208 enables a user to update user information for a selected user and make any desired changes to the profile information for the selected user, including altering their working group within the ERM software 10 (e.g., administrator, inventory manager, general user, or the like). A selected user may also be flagged from this page. Flagging a user entails marking their profile with a warning and/or blacklisting that user from obtaining company/business resources from specific events (e.g., Eagles tickets if they behave badly at a game, or the like). A selected user's account may also be suspended so the selected user may not be able to login to the ERM system. This saves an administrator from removing their account completely. A selected user may also be banned from the ERM system so that they are unable to apply for membership or utilize the ERM software as long as the ban is in effect. The DELETE SPECIFIC USER page 210 enables a user to remove a selected user from the ERM database 150 permanently.

The ADMINISTRATION ALL USERS VERIFICATION LIST page 212 enables a user (e.g., an administrator or the like) to view applications from users desiring to become a member of the ERM system, and to approve and/or decline their membership. When a user applies to use the ERM system and become a general user of the ERM system an administrator needs to approve them before they are actually allowed to access the user side of the ERM software 10. This forces each user to be screened by an authority inside the company/business. The ERM database 150 may also utilize a specialized function within the ERM software 10 that allows the ERM system to connect directly to the Active Directory (AD) structure of the company/business pulling from it Names, username, group, and other personal information using Lightweight Directory Access Protocol (LDAP). The enterprise resource manager may also capture the organization of the company/business from the AD structure as well as create an organizational chart within the ERM software 10 based on the user/member structure within the AD.

The VERIFY SPECIFIC NEW USER INFORMATION page 214 enables a user to view the entire profile of an applicant seeking membership into the ERM system. The VIEW ALL CLIENTS page 216 enables a user to view all of the clients that have been entered into the ERM system. The ERM system can distinguish between various types of membership. A direct membership of a user is different from the membership of a client or charity.

The ADD SPECIFIC CLIENT page 218 enables a user to add clients to the ERM system by entering information about them such as company/business name, contact name, contact information, phone numbers, or the like. The VIEW SPECIFIC CLIENT INFORMATION page 220 enables a user to view detailed profile information of a client stored in the ERM database 150. A user may alter and/or update a selected client profile using the MODIFY SPECIFIC CLIENT page 222, or delete a selected client from the ERM system using the DELETE SPECIFIC CLIENT page 224.

The VIEW ALL DISTRIBUTION GROUPS page 226 enables a user to view the existing organizational structure of the user, otherwise known as a distribution group. The term distribution group is used because the organization of this structure helps better target the distribution of system resources. A user may also assign managers to each distribution group that are users of the system to help delegate responsibilities of resources. The ERM system maintains a detailed record of the overview and organization of the associated company/business. The administrators of the company/business determine an organization chart and may use it to group users into company/business specific categories for distribution, shipping, payment of resources, or the like.

The ADD SPECIFIC DISTRIBUTION GROUP page 228 enables a user to add parent or child grouping to the organizational charts of the distribution groups. The VIEW SPECIFIC DISTRIBUTION page 230 enables 10 a user to view the properties of an organizational distribution group and to see who is already under that particular group. The MODIFY SPECIFIC DISTRIBUTION GROUP page 232 enables a user to modify existing groups and change the grouping structure of where they lay within an organizational tree. Users may also be added to the organizational branch using this page 232. The DELETE SPECIFIC DISTRIBUTION GROUP page 234 enables a user to remove an entire branch of an organizational tree and remove users from a specific distribution group as well.

The VIEW ALL CHARITY INFORMATION page 236 enables a user to view charities associated with the company/business in a list. The ERM software 10 keeps track of charities which may be partnered with the company/business associated with the ERM software 10. Company/business resources such as money, tickets, or the like, may be offered as charitable donations to these charities. The ADD CHARITY page 238 enables a user to add an affiliated charity to the ERM database 150 by entering in specific information about the particular charity, such as their name, contact information, federal charity ID, or the like. The MODIFY CHARITY INFORMATION page 242 enables a user to alter any information about a particular charity. The DELETE CHARITY page 244 enables a user to remove any charity from the ERM database 150.

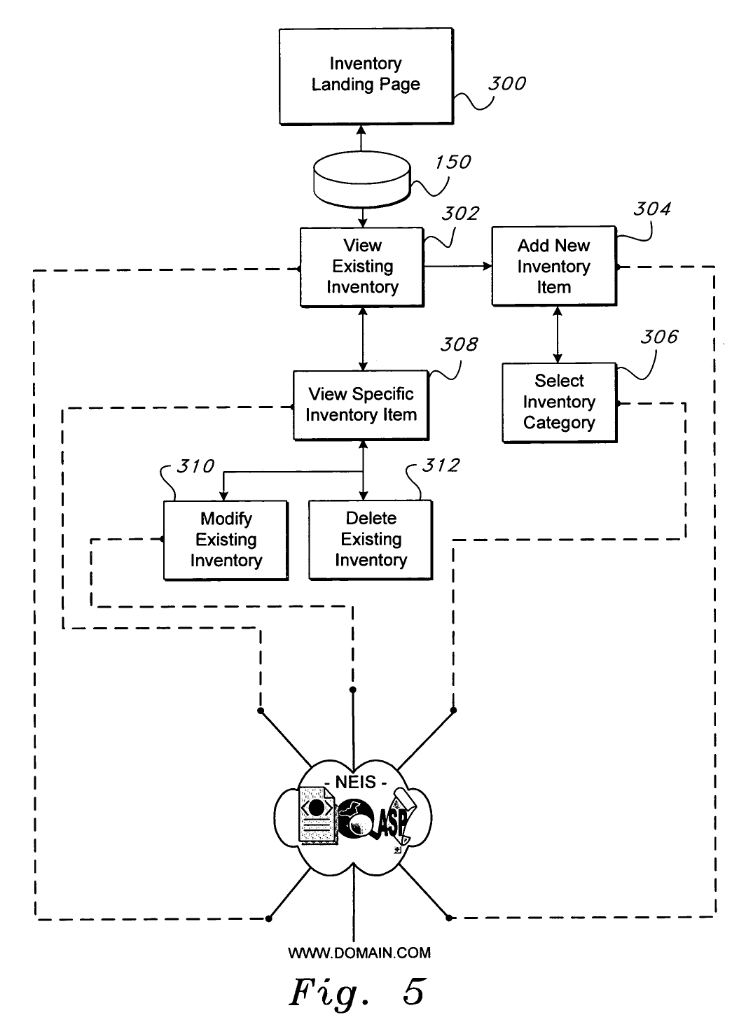

FIG. 5 shows inventory processes available to a user after accessing the INVENTORY LANDING page 300. The INVENTORY LANDING page 300 provides a link to all of the functions needed to add, update, and delete inventory in the ERM database 150. There are two possible inventory management interfaces that an administrator may access. The first is a standard management interface and the second is a management interface that deals in large quantities of resources and has a number of functions that aid in the management of mass-quantities. The second management interface is referred to as the inventory manager plus. The VIEW EXISTING INVENTORY page 302 enables a user to search and view existing inventory in the ERM system. Depending on the administrator's group role, only certain inventory may be available to them. This function provides a list to the administrator of current inventory to work with in the ERM database 150.

The ADD NEW INVENTORY ITEM page 304 enables a user to add inventory to the ERM database 150, and group and/or earmark the inventory according to the desires of the user. The resource groups may be specified and added as needed with these functions. Each resource utilizes a specific event or resource identification (ID) from the ERM system to relate the resource to an event or need for distribution. This event/resource ID is determined by either the National Event Index Service (NEIS) or a localized database structure containing company/business specific events.

The NEIS is a remote web service that feeds current event information to the ERM system to relate the resource to a corresponding category. The NEIS provides customers with a fully integrated and up-to-date information distribution system. This system offers a multitude of information about sporting, entertainment, and other events. The NEIS offers a host of data that extends well beyond the scope of just event name and time. The system may utilize the Microsoft .NET Framework or the like to build other applications that need data dissemination of this type.

The ERM software 10 allows qualified subscribers to link to the data center of the developer of the ERM software 10 and retrieve such information as event name, venue information, local attractions, restaurants, directions, event categories, or the like. The user may connect and build this technology directly into their software using any number of technologies including but not limited to PHP, ASP, ASP.NET, VB, C, HTML, XML, or the like. Each paying customer may be granted access depending on how much information they would like to retrieve from the system. There may be multiple types of subscriptions that may access different parts of the system such as restaurants, local attractions, and directions.

The SELECT INVENTORY CATEGORY page 306 enables a user to attach a newly added resource to an event category or resource category. The ERM system uses the NEIS or local event structures to determine the linking event ID. The VIEW SPECIFIC INVENTORY ITEM page 308 enables a user to view specific information within a resource group in the inventory in the ERM database 150. The ERM software 10 may display the current status, price, owner, distribution group, or the like. The MODIFY EXISTING INVENTORY page 310 enables a user to update a resource or group of resources if the particular resource is not bid on, distributed, or paid for by an end user. Changing the price, locale, or pertinent data about a particular resource after an agreement with an end user is invalid within the ERM system. The DELETE EXISTING INVENTORY page 312 enables a user to delete a resource group. The rules prohibiting a user from deleting a resource group are similar to the rules for updating a resource group. If the resource is in use or has not been archived after it has been distributed, the ERM system does not allow a resource group to be removed.

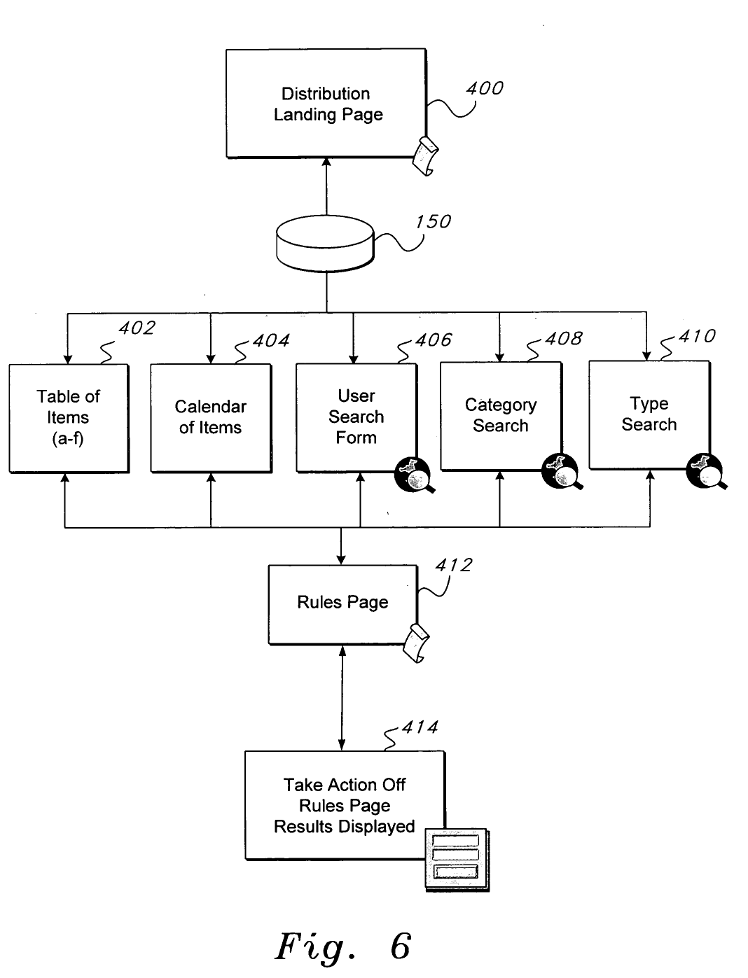

FIG. 6 shows distribution processes available to a user after accessing the DISTRIBUTION LANDING page 400. The DISTRIBUTION LANDING page 400 links a user to all of the functions within the distribution section of the ERM software 10. The distribution section is uniquely designed to handle multiple requests on a resource group for distribution. As such, the ERM software 10 handles all of the distributions similarly by addressing only the next step in the phase of linking a resource to a user. The TABLE OF ITEMS page 402 displays resource groups inside one of six lifecycle categories. These categories include, but are not limited to, open, pending distribution, distributed, on hold, allocated, and unallocated. Each resource should fit into one of these six categories. This page 402 displays a table of resources that is broken into these categories on selection.

The CALENDAR OF ITEMS page 404 offers a calendar that a user may interact with to select resource groups whose events take place on a particular date of selection. The user may select certain months, weeks, or dates that display resource groups that are applicable to those dates. The USER SEARCH FORM page 406 enables a user to search through resource groups that are interacting with specific users within the ERM system. Search criteria may be based around one user who is requesting, receiving, or has been granted a resource.

The CATEGORY SEARCH page 408 interacts with the NEIS system and a Local Event Index System (LEIS) to find resources that are within a category of choice by the user. For example, if the user wishes to find all resources or tickets to an NFL game they may use this search function. The TYPE SEARCH page 410 enables a user to type in freeform text and search the ERM database 150 for associated resource groups.

The RULES page 412 represents a uniquely functioning piece of software that adapts to a resource that is selected to be handled on the RULES page 412. The functions only bring up selections and criteria about the resource that is applicable to the resource at that time. For example, if a resource is being raffled, raffle functions are offered to a user instead of functions used by an administrator fulfilling requests for a resource. The ERM software 10 associated with the RULES page 412 determines the next step to every resource distribution and guides a user through each process. The distribution of any resource may be altered at any time manually and the process may be overridden according to the desires of the user.

The TAKE ACTION OFF RULES PAGE RESULTS DISPLAYED page 414 is hidden to the user but is a crucial piece of intelligent data manipulation within the ERM software 10. The script associated with the page 414 handles all of the user requests by an administrator during the distribution and delivers the correct data to the rules page for the next step in handling a particular resource.

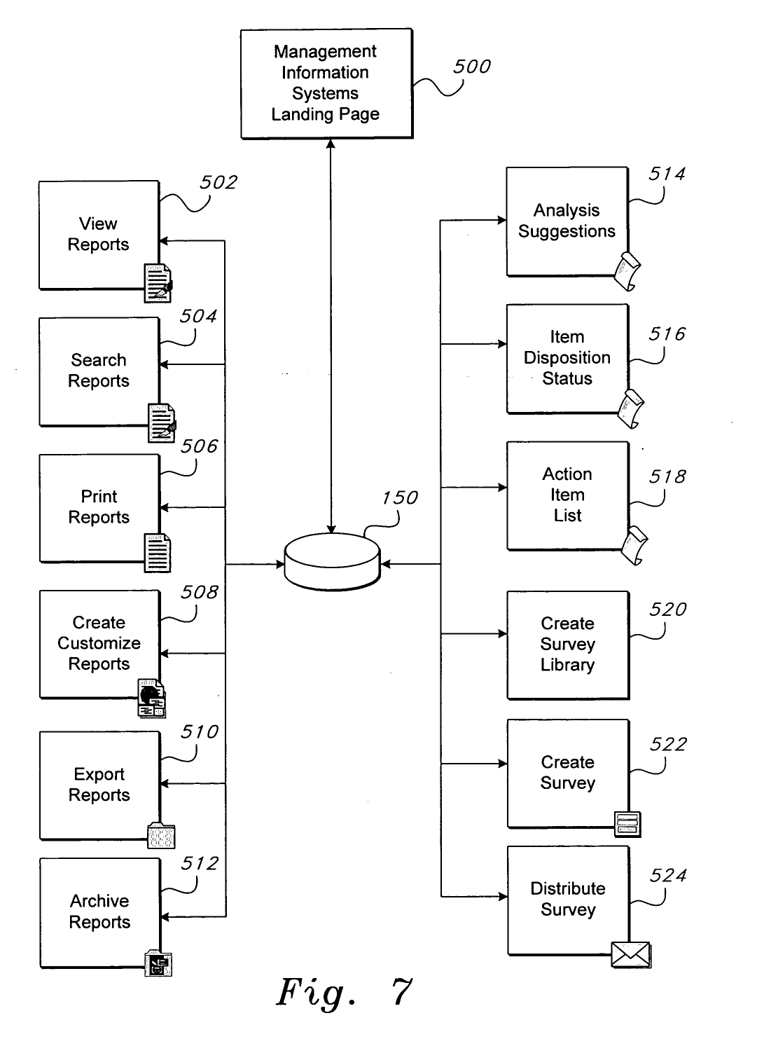

FIG. 7 shows management information systems processes available to a user after accessing the MANAGEMENT INFORMATION SYSTEMS LANDING page 500. The MANAGEMENT INFORMATION SYSTEMS LANDING page 500 gives a user complete control over statistics and data tracking within the ERM software 10. From this page 500 a user may perform all of the reporting duties that the ERM system offers.

The VIEW REPORTS page 502 displays statistics that have been calculated in the ERM system concerning the resources and users that have been chosen by an administrator. The SEARCH REPORTS page 504 enables a user to search the ERM database 150 for specific data that may be mission critical in running the user's day-to-day operations. The PRINT REPORTS page 506 enables a user to stylize and print out reports in a hard copy. The ERM software 10 may be configured to email reports and utilize an online fax system.

The CREATE CUSTOMIZE REPORTS page 508 enables a user to create and customize the data output from the reporting system inside the ERM software 10. The EXPORT REPORTS page 510 enables a user to save a report in a number of formats which include but is not limited to Microsoft Word (.doc), Excel (.xls), PowerPoint (.ppt), or even a proprietary ERM specific format that holds data concerning charts, graphs, and preferred statistics. The ARCHIVE REPORTS page 512 enables a user to archive the ERM database 150 and tracking system into customized file formats (.erm). The archiving functions effectively backup all statistical data inside the current data tables.

The ANALYSIS SUGGESTIONS page 514 analyzes the current status of a particular inventory and distributions and makes detailed, intelligent suggestions to the associated user including hints on procurement and efficient distribution policies. The ITEM DISPOSITION STATUS page 516 enables a user to view the previous and current lifecycle status of a resource group. The ACTION ITEM LIST page 518 is associated with a special piece of software contained within the ERM software 10 that provides a snapshot of critical action items that are pending in the ERM system. The ERM software 10 displays the most important items of consideration in red at the top of a table, the non-critical pending items in the middle of the table in yellow, and the least important items for consideration in green at the bottom of the table. The user may click on any of the items and the system will direct them to the appropriate actions to take on the resource. For example, if a resource were distributed and needed to be shipped within less than a twenty-four hour time span the resource and explanation of what action should be taken will be displayed at the top of the action item table in red. If the resource is allocated and needs to be distributed to a user in the next month, the system would display the resource at the bottom of the table in green.

The CREATE SURVEY LIBRARY page 520 enables a user to create and form their own personalized surveys and feedback forms by adding, modifying and/or deleting questions and forms from the ERM database 150. These surveys may be attached to any distribution to increase pipeline efficiency and retrieve required information for tax forms as well as assess the impact of the resources on clients and sales initiatives. The CREATE SURVEY page 522 enables a user to pick from the library questions and forms that have either been pre-populated in the ERM software 10 or downloaded from the ERM software 10 distributor's web site in order to place them together in one survey. The user may name the survey and file it for use with distributions. The DISTRIBUTE SURVEY page 524 enables a user to push a survey to any user at any time. A survey is normally issued at the time of distribution for a resource.

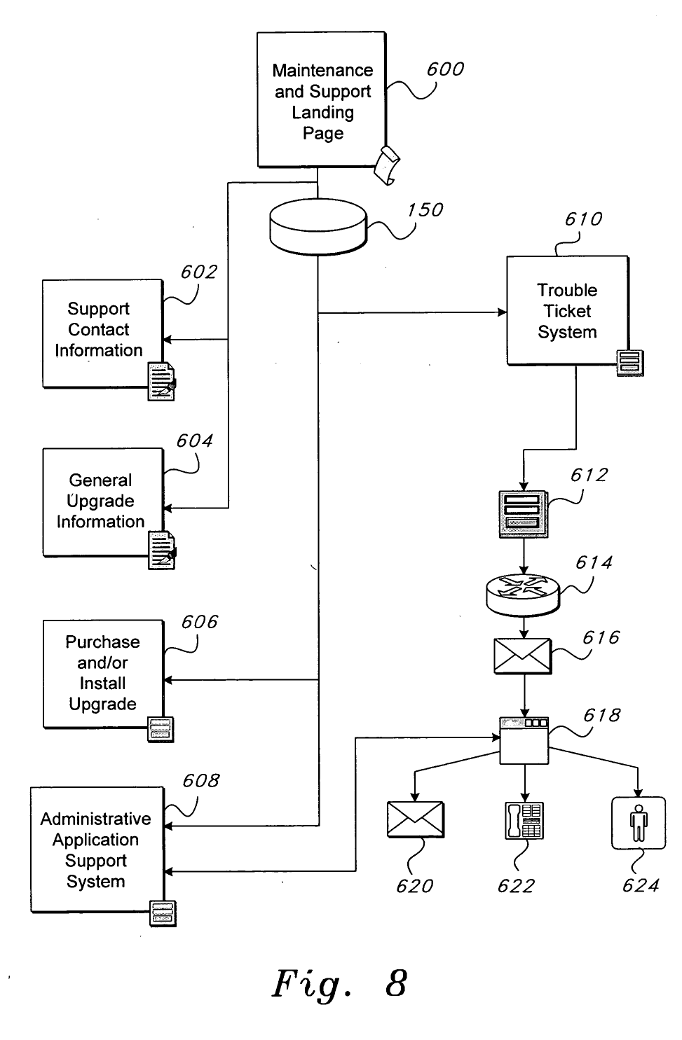

FIG. 8 shows maintenance and support processes available to a user after accessing the MAINTENANCE AND SUPPORT LANDING page 600. The MAINTENANCE AND SUPPORT LANDING page 600 lists the general contact information for the developer of the ERM software 10 as well as a current technical representative for the company. The SUPPORT CONTACT INFORMATION page 602 offers an explanation of the current version of the ERM software 10 that the associated company/business has running and offers any upgrades and up sell information from the developer of the ERM software 10. The PURCHASE AND/OR INSTALL UPGRADE page 606 enables the company/business using the ERM software 10 to purchase new upgrades or software for the ERM software 10 and install the upgrades locally through a web download if possible. The ADMINISTRATIVE APPLICATION SUPPORT SYSTEM page 608 represents a trouble ticket web service that is offered to the company/business and is the application by which the administrator of the company/business handles opened tickets.

The TROUBLE TICKET SYSTEM page 610 handles all of the trouble tickets for the company/business and is the technical online bridge between the company/business and the developer of the ERM software 10. The trouble ticket system enables a user to open a ticket with a technical representative of the developer of the ERM software 10 and explain the problem online to them. The ticket is then opened and submitted to the developer of the ERM software 10 from WITHIN the ERM software 10. The ticket enters into the trouble ticket web service of the developer of the ERM software 10 and is responded to automatically by in-house software. The ticket is then assessed by the technical representative and one of three responses is generated: (1) an email 620 is sent with the solution to the problem; (2) a call 622 is made to the company/business for support; or (3) a service representative 624 is sent onsite or online into the ERM software 10 to correct the problem.

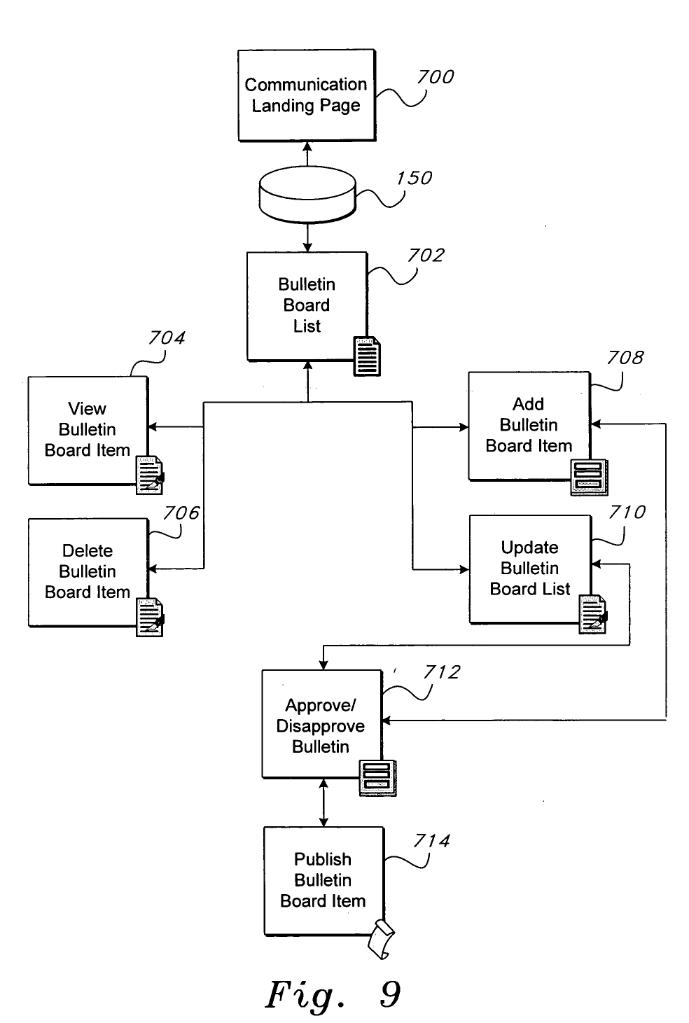

FIG. 9 shows communication processes available to a user after accessing the COMMUNICATION LANDING page 700. The COMMUNICATION LANDING page 700 enables a user to utilize the communications tools of the ERM software 10. The BULLETIN BOARD LIST page 702 lists current bulletins that may be published on a company/business wide bulletin board. The VIEW BULLETIN BOARD ITEM page 704 enables a user to view the contents of any bulletin that is currently published on the company/business wide bulletin board, such as the title, date, body text, or the like. The delete bulletin board item page 706 enables a user to delete a bulletin board item if the user is the owner of the bulletin board item. A fully privileged system administrator may also delete a bulletin board item.

The ADD BULLETIN BOARD ITEM page 708 enables a user to add or update a bulletin board item based on the administrator groupings in the ERM software 10. A fully privileged administrator may approve or disapprove any bulletin that a subordinate wishes to post. This approval must take place every time a bulletin is added or updated to ensure that the bulletin is qualified to be seen company/business wide. The UPDATE BULLETIN BOARD LIST page 710 enables a user to update any information pertaining to a particular bulletin. The APPROVE/DISAPPROVE BULLETIN page 712 enables a ruling administrator to approve or disapprove a bulletin based on the author and contents. The PUBLISH BULLETIN BOARD ITEM page 714 is hidden to the user, and publishes a bulletin board item to the ERM system and qualifies the bulletin board item for viewing by the company/business's user site.

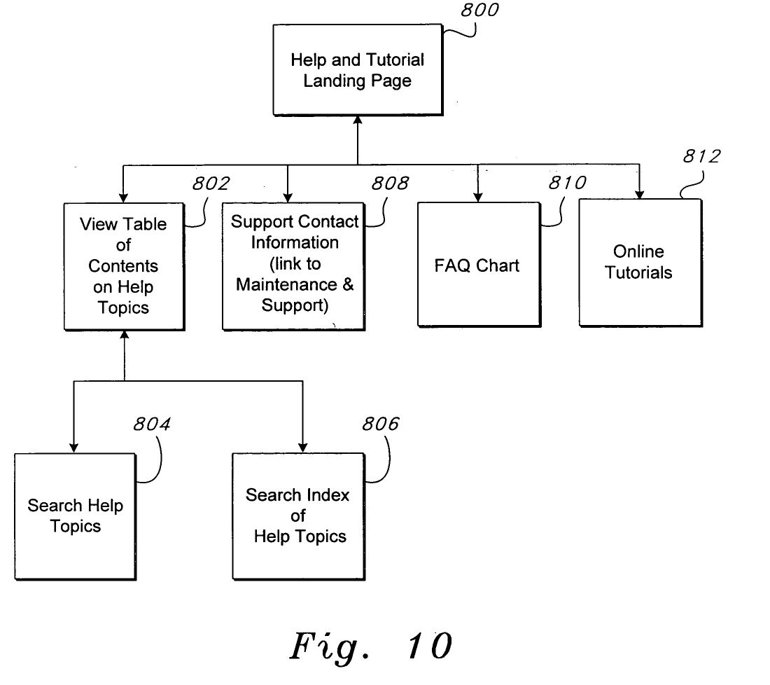

FIG. 10 shows help and tutorial processes available to a user after accessing the HELP AND TUTORIAL LANDING page 800. The HELP AND TUTORIAL LANDING page 800 enables a user find answers about the ERM software 10 when the user has a question about the inner workings of the ERM software 10. This section contains help and tutorial material for the user to become better acquainted with the ERM software 10. The VIEW TABLE OF CONTENTS ON HELP TOPICS page 802 provides a table of contents for help pages by section and category. The SEARCH HELP TOPICS page 804 enables a user to search the entire table of contents for a specific keyword(s) using freeform text. The SEARCH INDEX OF HELP TOPICS page 806 provides an indexed list of keywords to search through in alphabetical order. The SUPPORT CONTACT INFORMATION page 808 provides the support and general contact information for the developer of the ERM software 10. The FREQUENTLY ASKED QUESTIONS (FAQ) CHART page 810 provides a user with a sectionalized FAQ bank to search through for quick answers to questions. The ONLINE TUTORIALS page 812 links to constantly updated online tutorials that guide administrators and general users through the ERM software 10.

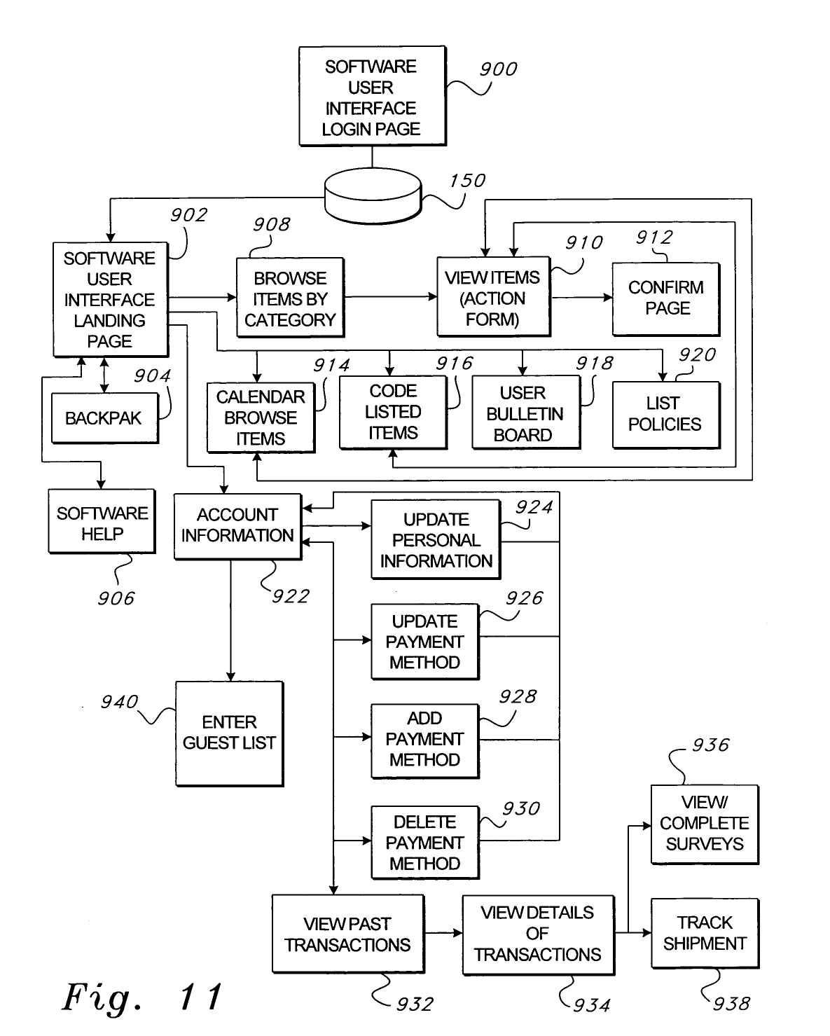

FIG. 11 shows software user interface processes available to a user after accessing the SOFTWARE USER INTERFACE LOGIN page 900. The SOFTWARE USER INTERFACE LOGIN page 900 enables an authorized user to login to the ERM system. A username and password is required for entry. A user profile must be approved by an administrator of the company/business to have access through the login software. The SOFTWARE USER INTERFACE LANDING page 902 is the main page that the users land on once logging into the SOFTWARE USER INTERFACE LOGIN page 900. This page 902 is somewhat different from the administration website and is designed around a simple user. From this section the user can access resources, update personal information, payment information, and perform other general tasks needed.

The BACKPAK page 904 displays incentives and awards for users. The BACKPAK page 904 represents a unique marketing tactic to keep users constantly visiting the site. The BACKPAK is used by an administrator of the company/business to offer incentives to users and provide them with a grab bag of offers that they may either choose to accept or turn down. The items that they turn down do not get re-entered into their BACKPAK and are not eligible to be requested by the user after that time. The BACKPAK is meant to spur impulse buys from the ERM software 10. The SOFTWARE HELP page 906 contains help documentation for the site and enables a user to search through a help index to aid in answering questions.

The BROWSE ITEMS BY CATEGORY page 908 enables a user to browse through existing resources in the ERM system that they have access to through the organizational and distribution groups set up by the administrator of the company/business. The VIEW ITEMS page 910 enables a user to view a particular resource group's properties, such as price, location of resource, or the like. This page 910 also allows users to take action of an item, such as request, enter a raffle, buy the resource, or the like. I the resource happens to be tickets or a resource used by other people the user may create a guest list and invite those guests via an email. The CONFIRM page 912 confirms the request to purchase of resources and gathers valuable information, such as shipping location, payment methods, or the like.

The CALENDAR BROWSE ITEMS page 914 enables a user to view a calendar of the year and select certain dates of interest. When a date has been selected, a list of events corresponding to that date will be listed to be viewed by the user. The interactive calendar function also enables requests to be made in case a user would like to attend an event or utilize a resource during a specified day or week and there are no resources or items currently listed. The CODED ITEMS page 916 enables a user to enter in a currently issued incentive code and view items that are listed under that particular incentive code. The USER BULLETIN BOARD page 918 enables users to view bulletins that have been posted by administrators, and enables management to communicate any important messages that must be relayed. The LIST POLICIES page 920 enables an authorized user to post any policies or change of policy concerning the usage of the site and the resources contained within.

The ACCOUNT INFORMATION page 922 displays personal information and user account information. This is the main page that lists a snapshot of a particular account. From here a user may update and access a number of functions related to the user. The UPDATE PERSONAL INFORMATION page 924 enables a user to update their personal information, such as address, phone numbers, name, email, or the like. The UPDATE PAYMENT METHOD page 926 enables a user to update any payment method information that may be currently in the ERM database 150. The add payment method enables a user to add a form of payment to use when purchasing or receiving resources from the ERM system.

A form of payment may be a credit card, E-check, PayPal ID, cost center ID, or the like. A company/business manager or administrator must approve the use of cost center ID. The DELETE PAYMENT METHOD page 930 enables a user to delete a form of payment from their account. The ERM software 10 may not remove the form of payment from the ERM database 150 if the ERM software 10 deems that the payment record is being used by a transaction. The form of payment will not show up in inventory but may still be located in the ERM database 150. The VIEW PAST TRANSACTIONS page 932 enables a user to view their past transactions for use of keeping record of their previous distributions and/or purchases. This page 932 displays their past transactions in a short list.

The VIEW DETAILS OF TRANSACTIONS page 934 displays details of the transactions either completed or in progress and offers such details as payment, price, tracking IDs, resource information, or the like. The VIEW/COMPLETE SURVEYS page 936 enables a user to view and/or complete surveys that an administrator may want the user to complete when the user is viewing transaction details. If the user is required to complete a survey or form, this page 936 enables them to access and fill-out the survey. When completed, the user may view their responses from this page 936.. The TRACK SHIPMENT page 938 enables a user to track packages that have been shipped. This page 938 links to the package carrier's tracking service to deliver package tracking data. The ENTER GUEST LIST page 940 enables a user to handle a guest list for any currently allocated resource in the ERM system. If a resource requires a formal guest list to be completed, the user may enter information such as their guests' name, job title, company, email, or the like. This list may also be used to ‘e-vite’ the guest and get a confirmation from them over the web.

As described above the variety of users who may use the ERM system may be categorized into groups of users including a SITE ADMINISTRATOR 18, a SITE ASSISTANT ADMINISTRATOR 20, an ITEM MANAGER 22, a GENERAL USER 24, an INVENTORY/SCHEDULE MANAGER 26, a REPORT MANAGER 28, a DISTRIBUTION MANAGER 30, a SYSTEM ADMINISTRATOR 32, and a HUMAN RESOURCE MANAGER 34.

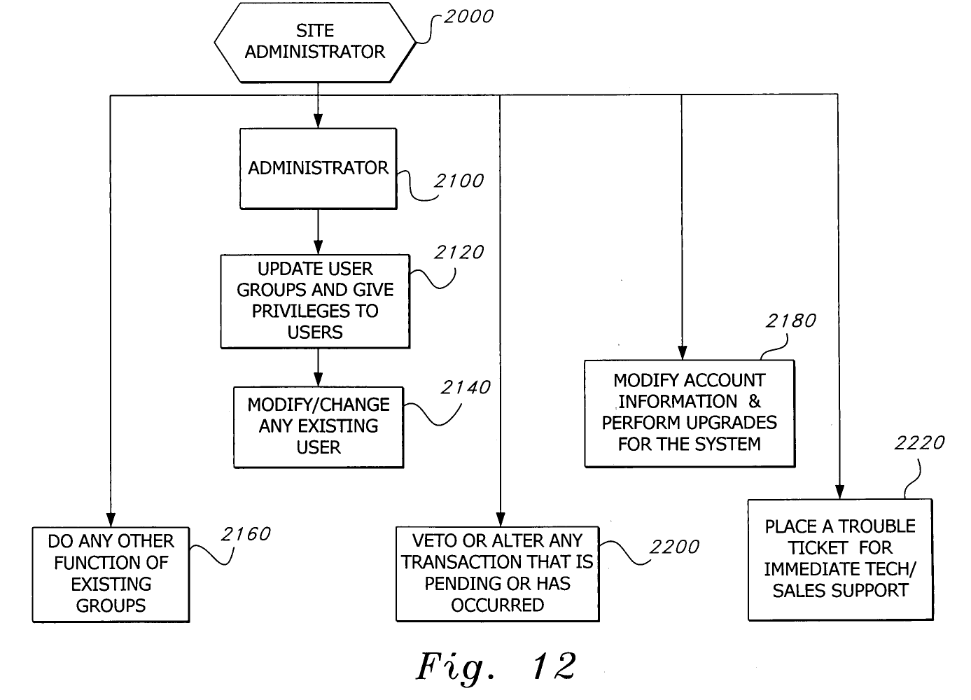

FIG. 12 illustrates a SITE ADMINISTRATOR process layout. A SITE ADMINISTRATOR 2000 has access to every function that the ERM software 10 has available. This role is vital especially in smaller companies where positions must be multitasked due to the lack of an abundance of human resources. The SITE ADMINISTRATOR 2000 is also a primary contact for the developer of the ERM software 10 and is the liaison between their company/business and the developer. An administrator position 2100 may be given to a person who will be spending the most time with the ERM software 10 and knows it the best. This person receives training and materials from the developer of the ERM software 10 in order to fulfill their role depending on the package they purchase from the developer. They should be available to answer any questions regarding the resources, software, decisions, and is accountable for every other position in the system as they have the ability to alter anything they desire.

In addition to other responsibilities, the administrator 2100 has the ability to update all of the user groups and assign or remove privileges of the system from any user at any time 2120. The administrator 2100 is responsible for determining job functions and roles of every manager and may suspend them if need be from the ERM system. The administrator 2100 may also alter any manager or user profile for any reason within the system and add or remove them from any group 2140.

The SITE ADMINISTRATOR 2000 may perform any task of the other types of managers 2160. The SITE ADMINISTRATOR 2000 has the right to veto any distribution of any resource to any user no matter what level they may be at to correct mistakes or allocate resources for urgent purposes 2200. The SITE ADMINISTRATOR 2000 may also suspend any transaction that has taken place and refund money to users if need be for money put through the ERM system.

The SITE ADMINISTRATOR 2000 has the ability to update company/corporate account information in the ERM system. This information may include company/business address, contacts, billing methods, or the like. In cases of system upgrades the SITE ADMINISTRATOR 2000 is able to enable the system to be upgraded via the web and authorize any work that needs to be done to the ERM system 2180. The SITE ADMINISTRATOR 2000 may call or place a trouble ticket with the developer of the ERM software 10 if the ERM software 10 is not properly operating and/or the user base is having troubles related to software issues 2220. The SITE ADMINISTRATOR 2000 may get immediate service from the developer of the ERM software 10.

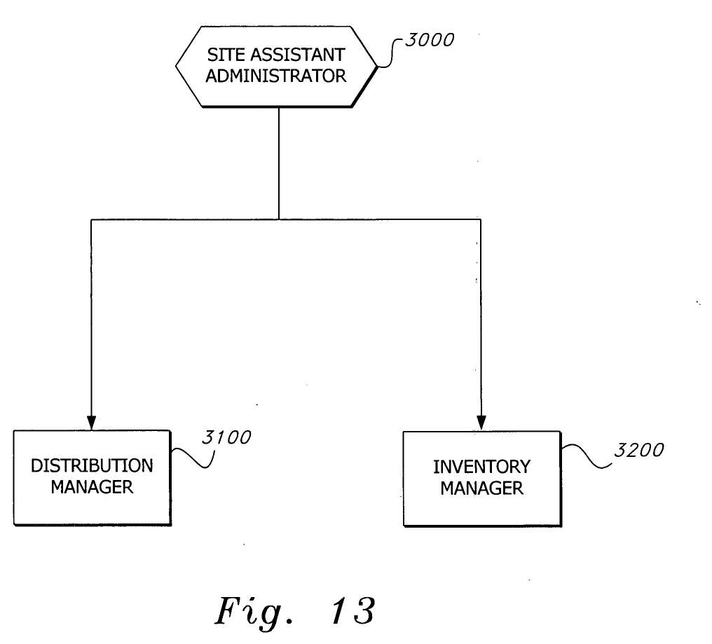

FIG. 13 illustrates a SITE ASSISTANT ADMINISTRATOR process layout. The SITE ASSISTANT ADMINISTRATOR 3000 represents a temporary position for an individual who is given temporary rights when the SITE ADMINISTRATOR 2000 is away for personal or business reasons. The SITE ASSISTANT ADMINISTRATOR 300 fulfills both the distribution manager's role and inventory manager's role allowing them to successfully handle all resources until the SITE ADMINISTRATOR 2000 returns. This temporary position may be delegated long term and also may be shaped differently depending on a company/business's desires.

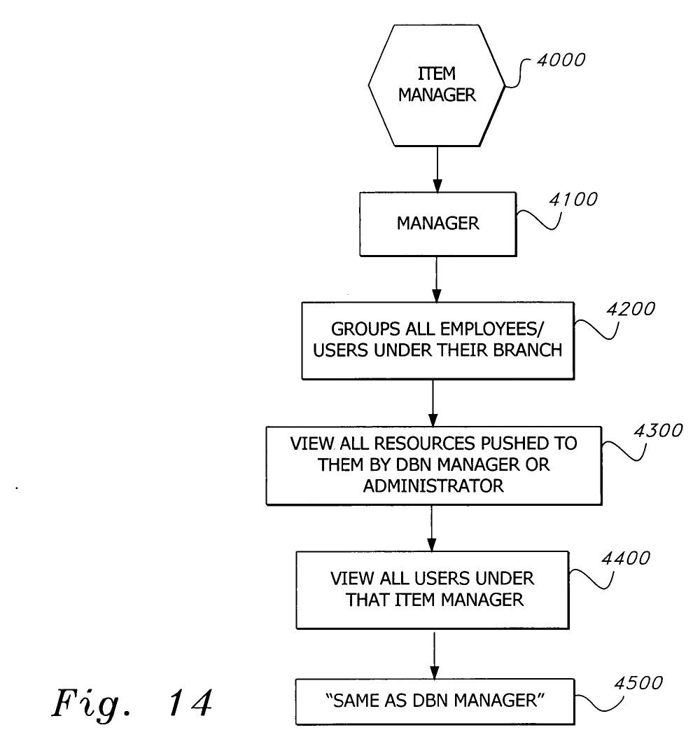

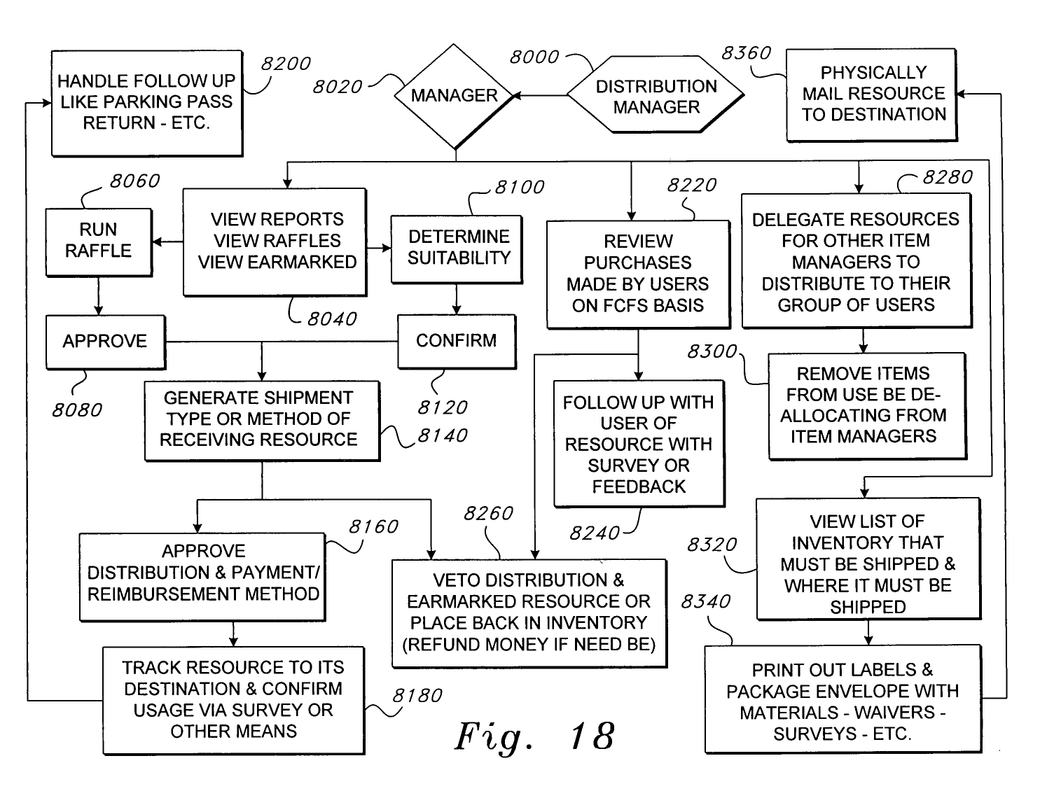

FIG. 14 illustrates an ITEM MANAGER process layout. The ITEM MANAGER 4000 is a counterpart to the DISTRIBUTION MANAGER 8000 (see FIG. 18) and has many of their duties with the exception that the ITEM MANAGER 4000 has control over a limited amount of resources that the DISTRIBUTION MANAGER 8000 gives to them. The DISTRIBUTION MANAGER 8000 has control over the entire inventory. The roles of the two managers 4000 and 8000 are very similar to each other.

The ITEM MANAGER 4100 is vital as it breaks the organizational structure into a hierarchy that can be positioned in any way the company/business sees fit. Many companies may use these ITEM MANAGERS 4100 as the head of a cost center would be used. In many cases, a cost center administration may even take on the role of an item manager.

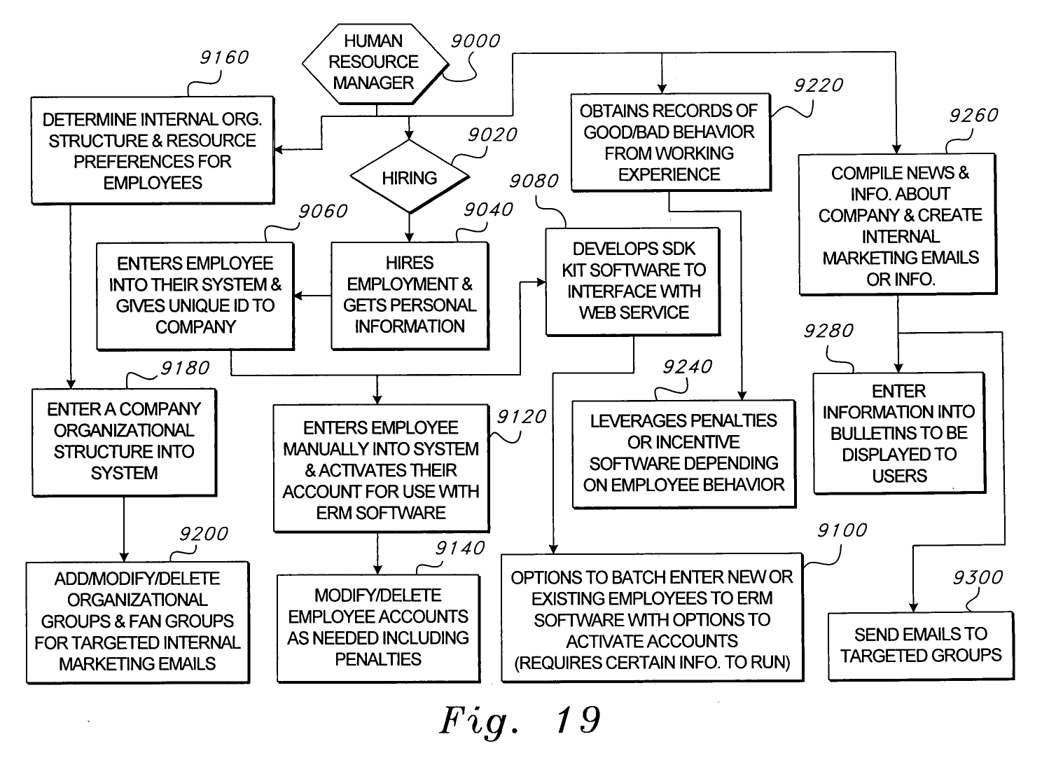

The ITEM MANAGER 4100 is responsible for making sure each employee under them has registered in the ERM system and has been grouped under them 4200 by the HUMAN RESOURCES MANAGER 9000 (see FIG. 19). The ITEM MANAGER 4100 is responsible for each of his/her employees and is able to distribute only those resources that upper management sees fit for them to offer. The ITEM MANAGER 4100 is only able to view those resources that are currently under them or pushed into their queue for distribution 4300. They may do whatever they like with their resources and perform all of the duties that the DISTRIBUTION MANAGER 9000 may perform. They may also see all of the employee profiles under them so that they make sure their group has been registered into the system and that any employees not registered do so 4400. They do not have the functionality of the HUMAN RESOURCES MANAGER 9000, but simply the ability to see the users under their management and their personal information. As stated before, the ITEM MANAGER 4100 can perform all of the duties that the DISTRIBUTION MANAGER 8000 can perform but only on their specific subset of resources.

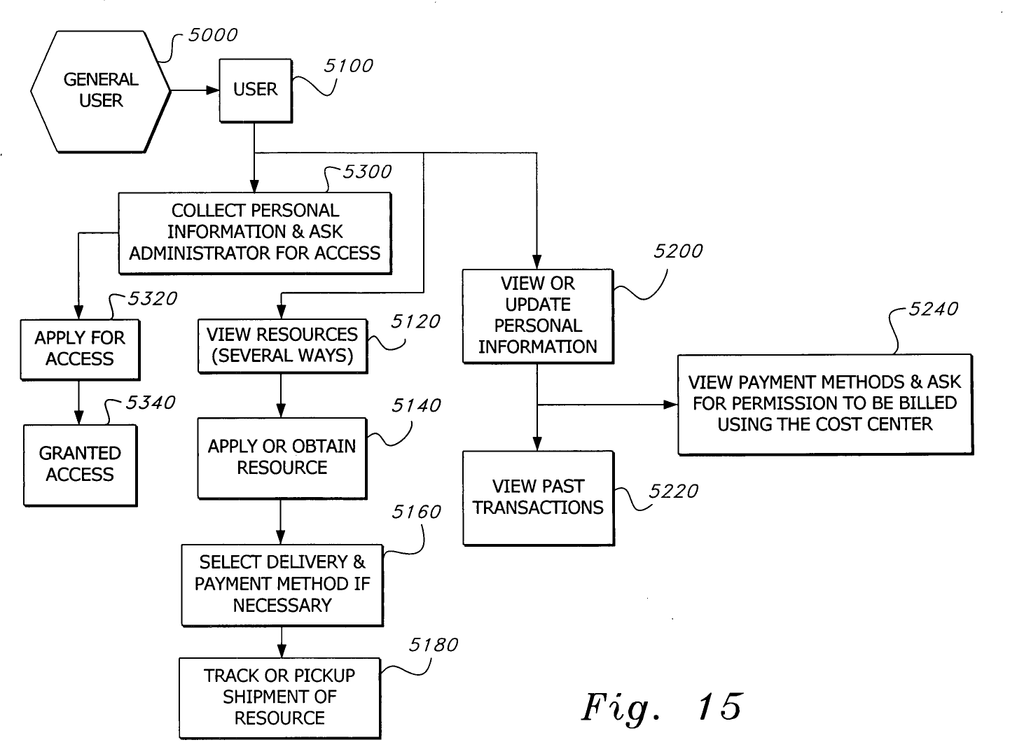

FIG. 15 illustrates a GENERAL USER process layout. A GENERAL USER 5000 is an employee, client, charity, or other person that may have access to the ‘general users’ side of the ERM system. This user 5000 has no administrative access although administrators may have access to be a general user. The general user 5000 accesses a special side of the system software that only allows them to view the resources and request, obtain, or buy them from the company/business.

The GENERAL USER 5100 only has access to one side of the ERM software 10 and never has access to the administrative or managerial portions of the ERM system. The general user population comes from a number of sources. The human resource manager 9000 enters the profile of the user in manually, the user enters their own profile into the system, or using a Software Development Kit (SDK), the company/business is able to link and replicate their user database with the ERM database 150. The company/business is also able to import their current Active Directory users into the system using the ERM software 10.

The GENERAL USER 5100 may collect their personal information and may only access a very specific portion of the general user site that allows them to enter this information into the ERM system 5300. The GENERAL USER 5100 is not able to see anything without proper access into the ERM software 10. Once all of their personal information is entered into the form fields they must create a login account for the ERM software 10. When complete, the application for acceptance is passed onto the SITE ADMINISTRATOR 3000 or HUMAN RESOURCE MANAGER 9000 of the system for approval 5320. If the GENERAL USER 5100 is valid, an administrator or manager will grant them access to the ERM software 5340. The user will get an email back stating whether they have been granted or denied access to the ERM software 10 when the decision is made. If they are denied, the SITE ADMINISTRATOR 3000 has the ability to add comments as to why they were turned down.

The GENERAL USER 5100 is allowed to see the resources within the ERM system that are available to them. Sometimes the user may see every resource in the inventory. Other times, the company/business may choose to limit what each user sees to the items in the inventory assigned to the managers that control that user. They may search through the inventory in a number of ways, such as by category, date, price, type of distribution, or the like 5120. There are a number of search interfaces open to the user to find their way to a suitable resource that interests them.

They may, depending on how the resources are being distributed, apply to obtain them 5140. In the case that a resource is first come first serve they may obtain the resource themselves without approval. In other cases they must submit their name and wait for a response. Depending on what type of distribution method the user may select a shipment method to obtain the resources as well 5160. They may select from a variety of shipment companies, such as UPS, FedEx, the USPS, or the like. Along with this selection, if they must pay for the resources they have to enter a valid form of payment, which may include eChecks, PayPal accounts, credit cards, cost center (if approved), or the like.

While their resources are in-route, if the shipping company has a method for tracking the package the ERM software 10 allows the user to track the package all the way to the package's destination and in some cases sign for the package with their signature on record 5180. The GENERAL USER 5100 may also view and update any personal information that they entered upon registration with the exception of their username that is a unique identifier of the account 5200. This information includes things such as password, address, phone numbers, company, birthday, other items, or the like.

The user account information includes all of their past receipts of resources, distributions involving that account, and transactions linked to their account that occurred within the ERM system 5220. They may see a description of the resources, date of transaction, account manager, billing information, shipment method, delivery information, guest lists, and other items related to the distribution like forms or surveys required. Finally, the user may be able to update billing information including adding, updating, and deleting methods of payment like credit cards 5240. They may apply for the usage of cost center codes in their account, which MUST be approved by a proper administrator (SITE ADMINISTRATOR 2000, ITEM MANAGER 4000, DISTRIBUTION MANAGER 8000, or HUMAN RESOURCE MANAGER 9000).

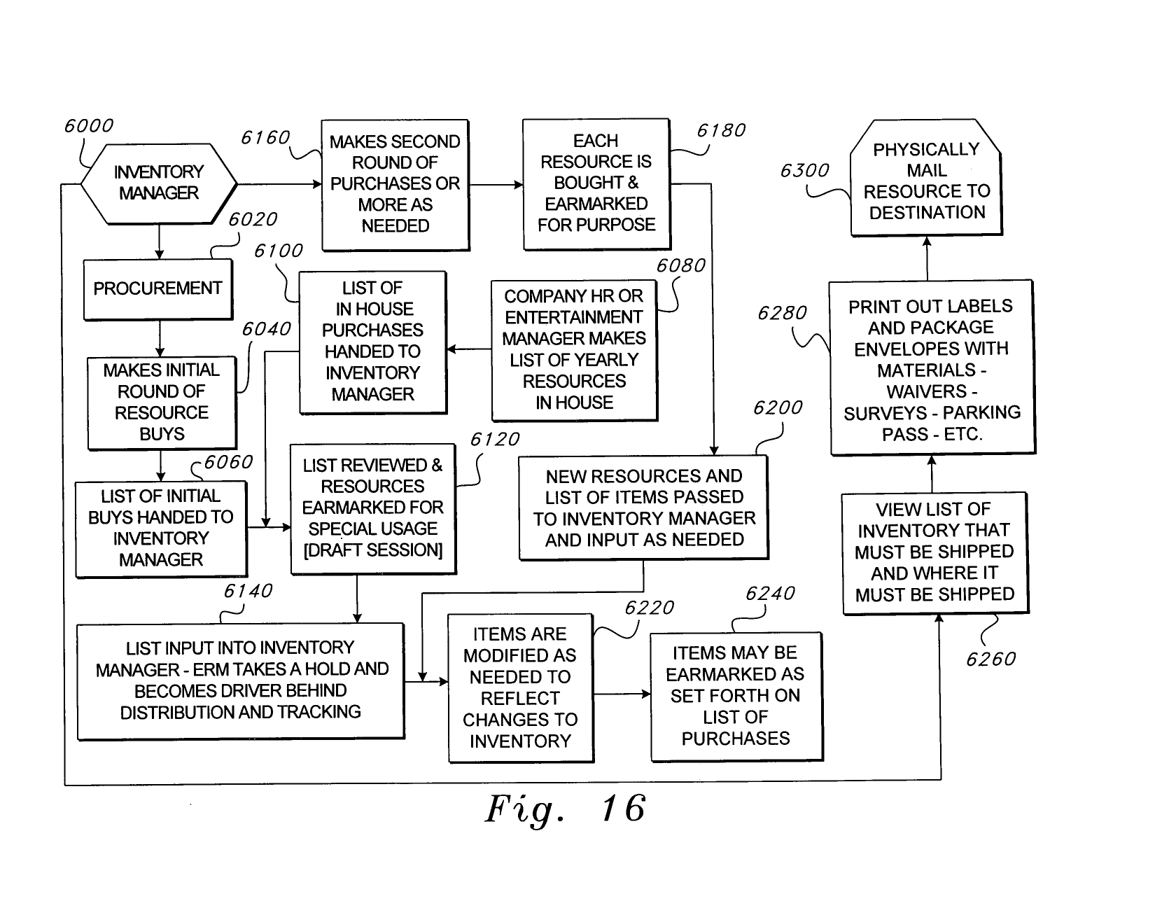

FIG. 16 illustrates an INVENTORY MANAGER process layout. An INVENTORY MANAGER'S 6000 job begins with procurement. The INVENTORY MANAGER 6000 looks at the overall stock of the company/business, the value needed from entertainment resources, the current inventory of the company, and the current budget to formulate what resources are needed by the company/business to fulfill the company/business's needs.

During the procurement phase 6020, the INVENTORY MANAGER 6000 looks at his/her statistics from the previous and current year to aid in determining what resources to purchase. The INVENTORY MANAGER 6000 also reviews archived data to calculate trends and demands. The INVENTORY MANAGER 6000 analyzes the current clients and target sales of the company/business to find out what kind of return can be made on specific resources and reviews the patterns and track record of the sales teams to get a handle on what clients respond best to business entertainment. All of these factors go into to making decisions on what resources to purchase for the company. Such thought and analysis are normally done outside of the ERM system. However, the ERM software 10 may also be configured to provide a user with links to outside resource(s) to assist in making such decisions.

At the makes initial round of resource buys stage 6040 the INVENTORY MANAGER 6000 has assessed what resources need to be purchased and begins to buy them from teams, venues, and vendors. This process may go on outside the ERM system in a manner where the manager or procurement officer keeps the purchase receipts. The ERM software 10 may also be configured to carry out this process stage. The purchases are compiled into one list or a master resource list 6060 that is then available for those individuals who need it. This list is then used later to refer to and each item is assigned an ID that is filed against the master list. A human resource or entertainment manager makes a list of yearly resources in house 6080. The particular manager(s) is/are responsible for all of the resources purchased for employees and internal use that could be distributed via the ERM software 10 to itemize a list of these resources. A list of internal resources that are available for distribution in the ERM system is sent 6100 to the INVENTORY MANAGER 6000.

Out of all the resources that come into the INVENTORY MANAGER 6000 there are specific ones that need to be used for predefined purposes. These resources can be designated as earmarked for the proper employee or client before they are even entered into the system. Many times, the company/business may go through a process similar to a draft pick of these resources 6120. This list of resources is entered into the ERM system using the necessary software utilities in the ERM system. At this point the ERM software 10 is aware of the resources and becomes the driver behind the distribution and tracking 6140. These resources may also be entered into the system by the INVENTORY MANAGER 6000 but not acted upon in any way by them. There is a fine line between distribution and the data entry and modification of the actual resource.

Concurrently, as this process moves forward the INVENTORY MANAGER 6000 or procurement officer may look into the purchase of more resources as needed. The INVENTORY MANAGER 6000 may review the concerns of their sales department and client entertainment needs on the fly and react by obtaining what is required 6160. These new resources are purchased and are generally earmarked because they are purchased on a need-based requirement 6180. Therefore, the list of who the resource is being earmarked for is created and handed to the INVENTORY MANAGER 6000 for the ERM software 10.

The data input step occurs and the resource is placed into the system to be managed just like the rest 6200. If the earmark becomes irrelevant the resource may go unallocated and is dealt with like the rest of the inventory. If the resource must be modified in any way the INVENTORY MANAGER 6000 has the ability to alter the characteristics of the item 6220. If a resource group must be updated or deleted, the inventory manager may perform this action at any time on the condition that the resource has not been fully allocated and shipped and/or paid for by a user. If at any point the inventory manager deems that a resource must be used for a specific purpose, they may earmark the resource at any time for that purpose provided that any owners of the resource be made aware that it is no longer available for allocation 6240. The ERM software 10 handles the ability to notify any of the owners of the resource in the event that the resource must be confiscated for another use.

The INVENTORY MANAGER 6000 may view a list of the inventory at any time 6260 and search by a number of different factors, such as date, price, owner, event name, or the like. This inventory displays all of the vital information concerning the associated resource group. The INVENTORY MANAGER 6000 may also take over the role of physical distribution since they are usually the ones that are physically in control of the resources. They can view a list of all of the resources that need to be shipped or given out including where the resources must be delivered.

The INVENTORY MANAGER .6000 is able to print out shipping labels and envelopes to physically mail the resources 6280. At this time, the list of packaging materials that must be included with the resource can be seen by the INVENTORY MANAGER 6000 so they can pack the item up to be shipped. The INVENTORY MANAGER 6000 or designated representative may physically drop the package off to be shipped 6300.

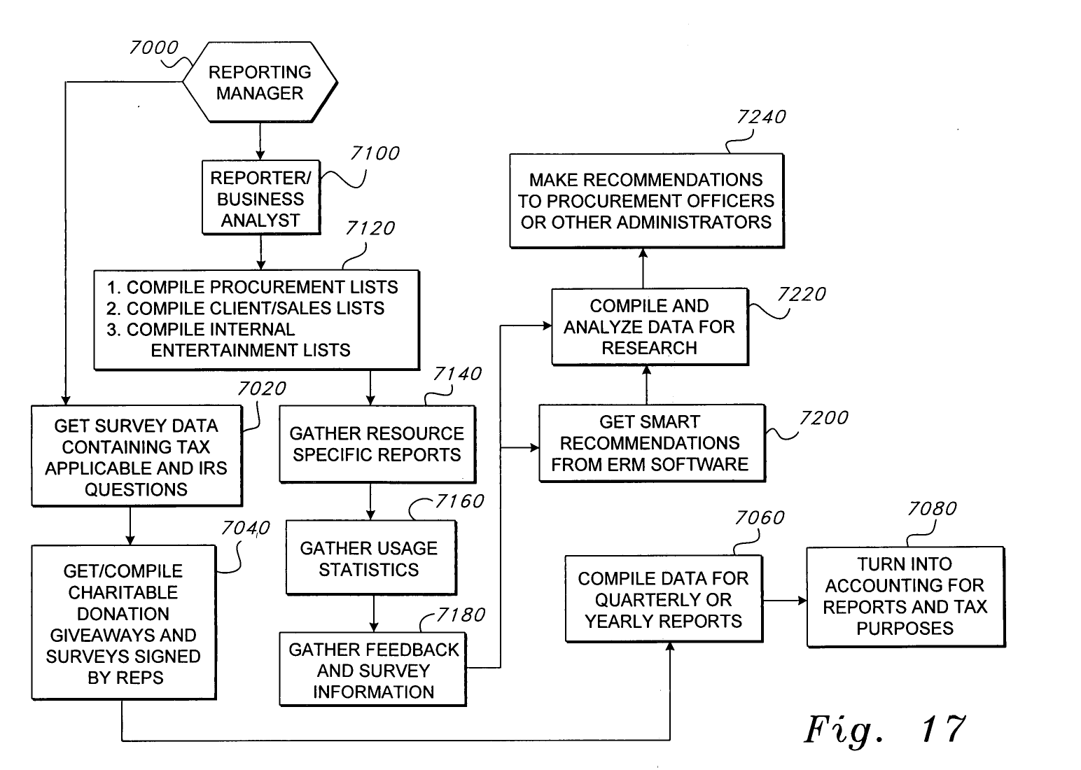

FIG. 17 illustrates a REPORTING MANAGER process layout. The REPORTING MANAGER 7000 plays a vital role in the management of resources within the company/business. This position is usually filled with business analysts that are in charge of determining the impact that these resources make on employee satisfaction, client satisfaction, client retention, and client pickup. The REPORTING MANAGER 7000 is able to see a snapshot of the productivity and performance of the ERM software 10 through built-in and managed statistical services.

One of the first jobs that the REPORTING MANAGER 7000 can perform is the collection and review of survey and form data that was emailed out to a user to be filled out 7020. This information is already stored in the ERM database 150 and can be accessed at any time by the REPORTING MANAGER 7000. The data may contain important survey information about enjoyment of the resource or tax information needed when entertaining clients.

The data that is stored from the surveys and forms comes in two forms. The ERM software 10 can breakdown down the data for individuals or may compile the data for the REPORTING MANAGER 7000 in order to quickly gather quantitative or qualitative information concerning the resources 7040. This information can also be broken down into types of returns such as charities, clients, employees, sales representatives or managers. From each group, data can be processed and used in a number of formats.

Once the data collected from the user feedback is pulled and compiled from the system 7060, the REPORTING MANAGER 7000 is then able to complete vital tax information, quarterly/yearly reports, employee survey reports, client satisfaction analysis, and other company/business specific items needed for the survival of the company/business. These reports can then be handed to the appropriate departments for review and action in the future 7080. For example, the client satisfaction surveys yield the result for current client retention based on the approval ratings of the business' customers. These reports may play a vital role in partnership planning, future client appreciation ventures, and pre-purchase of resources for the next year.

A reporter or business analyst 7100 has a number of reporting devices on hand built into the ERM software 10 to aid them in their job. The ERM software 10 is fully capable of returning set results as set forth by the REPORTING MANAGER 7000 for analysis. This means that the REPORTING MANAGER 7000 presets the ERM software 10 and configures the statistical returns to streamline the reporter/business analyst 7100 workflow. The ERM software 10 may also log and print out preformed reports with existing analysis in them.

This REPORTING MANAGER 7000 may need several pieces of information for in depth analysis 7120, such as a procurement list of existing resources, a list of clients and important sales, and a list of internal entertainment that the company/business facilitates. The procurement list and client/sales may be found in the ERM software 10 depending on how in depth the business uses the ERM software 10. These lists may help in future reporting and comparative analysis that the ERM system provides.

The ERM software 10 contains a number of statistical reporting tools, such as resource, client, employee, management, sales, cost center, monetary, usage, waste percentage, distribution time, and charitable donation analysis, or the like. From this pool, the REPORTING MANAGER 7000 may pull and compare any number of statistics that is vital to their job function 7140. The ERM software 10 may also produce dynamic graphs and charts that allow users to visually gather statistics. The ERM system may utilize custom developed software within the ERM software 10 or may charge the task to third party software. These graphs/charts are dynamic and allow for interaction between the visual representation of the data and the actual data inside the ERM database 150. By interacting with these graphs/charts users may pull up more specific data that is needed. For example, a visual representation of a graph/chart may show an inventory quantity in months along the x axis in bars. A user may then use a computer mouse to click on a particular month bar, such as January, and a daily breakdown of the inventory in the month of January may be displayed in bars rather than the monthly breakdown of the inventory.

The ERM software 10 may produce a report that measures the usage of the inventory and resources at hand 7160. Every report focuses on this one aspect in one way or another. The ERM system is configured to maximize the usage of resources within any company/business effectively and efficiently. From these statistics, even though the survey and form information may be accessed independently, the reporting software may gather quantitative data from these forms and average the data out 7180 for the REPORTING MANAGER 7000. This is the precompiled portion of that data that is available in cooperation with the other reporting features of the ERM system.

An option that is built into the ERM software 10 is a GETSMART ANALYSIS TOOL 7200. This reporting feature makes intelligent suggestions based on the data that comes into the system. This part of the ERM software 10 may offer tips on procurement, employee usage, and other management decisions. The ERM software 10 is meant as a supplemental analysis and not a decision making process. If the manager chooses not to use the GETSMART feature 7200 of the reporting tools, the next step is to take the findings and begin to compile them into a usable form for the company/business 7220. This data must be analyzed and reviewed in order to put it into a readable format. Finally, the reporting manager uses the analysis in making decisions that will aid the company/business in more efficiently managing corporate resources and streamline the process that is already in place 7240. This data is handed off to other administrators and procurement officers who gather the resources to begin the process all over again.

FIG. 18 illustrates a distribution manager process layout. The DISTRIBUTION MANAGER 8000 within the ERM system effects critical decision making processes of how and to whom the resources are distributed. There is a very close connection between the DISTRIBUTION MANAGER 8000 and the ITEM MANAGER 4000. These two are very close in functionality but play vital roles and warrant a distinction within the ERM system. The DISTRIBUTION MANAGER 8000 handles all distribution of resources from the inventory to the actual shipment to the end user. The ITEM MANAGER 4000 is given resources by the DISTRIBUTION MANAGER 8000 to spread amongst a limited group. An analogy may be made to a wholesale and retail store. The wholesaler manager can either disseminate his/her resources to a retail store or the general public (e.g., the DISTRIBUTION MANAGER 8000). The retail store receives a set of resources and sells them to the general public alone (e.g., the ITEM MANAGER 4000).

Each DISTRIBUTION MANAGER 8020 is designated depending on how much they deal with the distribution of resources to their employees. This DISTRIBUTION MANAGER 8020 is given the right to make independent choices on where the company/business resources should go. The DISTRIBUTION MANAGER 8020 acts as a trafficker of resources for the company/business and either distributes them himself/herself or delegates that responsibility to an ITEM MANAGER 4000.

The DISTRIBUTION MANAGER 8020 may go into the system and view the inventory but not alter it. This person 8020 acts solely on the notion that whatever is the inventory at a particular time must be used, sold, or given away. The DISTRIBUTION MANAGER 8020 may see the current inventory along with any comments about the resources and if they have been earmarked to be distributed to someone already. At this point, if the resource is not earmarked the DISTRIBUTION MANAGER 8020 may decide on how to use the resource or the method of distribution. The item may be given away in a variety of ways.

Resources may be given away through a raffle. When an item is raffled, a number of users apply to enter the raffle and when the DISTRIBUTION MANAGER 8020 is ready, he/she closes off the raffle to any more entries and the ERM software 10 automatically selects a user from the group that entered. The DISTRIBUTION MANAGER 8020 has the choice to either weight the raffle or not. By weighting the raffle, users who have not received as many resources from the system will be more likely to win but NOT guaranteed.

Another type of distribution is to earmark resources. The DISTRIBUTION MANAGER 8020 may mark a resource as already distributed even though it may not be used yet. The earmark may be for a whole division, a manager, or just one person. Another way resources may be distributed is through a first come first serve method where certain users may claim the resources according to what their particular group is. These resources may either be for sale or free. Resources may also be distributed by request. Each user may make a request for a resource and either the DISTRIBUTION MANAGER 8000 or ITEM MANAGER 4000 may approve or deny the request.

Resources may also be distributed amongst users through reselling. The ERM software does not actually make transactions of resources but keeps track of them. A company/business may want to make money back from their employees. This normally occurs at organizations but the employees pay for them via check or cash and the process is not consolidated. The ERM software 10 may place resources up for resale in a particular system and employees may buy them with credit cards which are charged through associated credit card service systems. The ERM software 10 may link to credit card service systems and obtain actual billing information for particular transactions.

Along with the standard information, a unique feature of the ERM software 10 is the ability of the users requesting the resources to enter a guest list for any resource. If the resource has to do with an event involving multiple tickets, the administrators or managers may request a guest list be filled in to allow them to view who will be attending a particular event. If the guest list meets the satisfaction of manager, they may use this information to decide who gets the resource. The guest list is completed by a general user with information such as name, title, company, age, or the like. General users may send email invitations through the ERM system to those person(s) on the guest list and, depending on how the company/business installs the ERM software 10, the guests may reply confirming their attendance and information via email or through an external link to the ERM software 10. This list may also be matched against the internal list of clients to provide tracking information about important clients.

If the distribution is done via a raffle 8060, the DISTRIBUTION MANAGER 8020 may decide to lock the raffle down and not let any more users apply for the resources. At any time the DISTRIBUTION MANAGER 8020 may manually add users into the raffle before the raffle is run or decide to cancel the raffle altogether. Once the DISTRIBUTION MANAGER 8020 is ready, he/she initiates the ERM software 10 to chose a winner of the raffle. Once the ERM software 10 decides the winner of the raffle, the user is notified of their winnings and the DISTRIBUTION MANAGER 8020 has a chance to provide a final approval of the winner or let the ERM software 10 approve the winner 8080. This process may be done via email and through the general user software functionality. An email may be generated and sent to the user with a link back to the ERM software 10 providing it with their decision.

When the DISTRIBUTION MANAGER 8020 decides to offer the resources in another manner such as earmark them, let users request them, let users buy them, or claim them for free, the DISTRIBUTION MANAGER 8020 determines the suitability of the users to have access to the resources 8100. For example, if three users request a resource the DISTRIBUTION MANAGER 8020 may determine which one would receive the resource. If a resource is earmarked the DISTRIBUTION MANAGER 8020 may have the ability to give the resource to a particular user or veto the distribution and give the resource to another user. At this point, no matter what method of distribution is used, the DISTRIBUTION MANAGER 8020 decides if the user receiving the resources is suitable. Once a user is notified that they will receive the resource, the manager confirms their decision 8120 and passes the resource along to the next stage to be sent to the owner of the resource.

At this point 8140, the owner of the resources has been established and the resource needs to get from its present location into the hands of its new owner. The DISTRIBUTION MANAGER 8020 must decide which method of shipment or transfer will take place. They may choose from a variety of methods including integrated shipping solutions providers such as UPS, FedEx, USPS, or the like. They may also choose to deliver the resources via an internal mail system. By choosing a particular method for receiving the resource an appropriate shipping label or envelope may be created. If a shipping label must be created, the ERM software 10 stores a label for printing by whoever needs to do so. The ERM software 10 also keeps track of the cost of shipping, delivery date, and various rates packages.

A final bill is generated (much like an invoice) to detail the entire record of the resource from the owner to the form of reimbursement to the shipment method 8160. The DISTRIBUTION MANAGER 8020 must finally approve the invoice and the resource is then marked for distribution to the correct owner. The reimbursement to the company/business for the resources is decided before the user accepts the resources but may come from the user, the company/business (as a sunk cost when purchasing the resource), or an outside source (such as a write off for charitable donation).

As the resource is shipped to the new owner the DISTRIBUTION MANAGER 8020 may track the package 8180 to the destination using built in third party tracking functions provided by UPS, FedEx, the USPS, or the like. At this point, the manager may also issue a survey or follow-up information gathering forms to the user for internal statistical reasons or tax purposes. These surveys and forms are dynamic and may be made up by the company/business at any time for any reason.

Many times if the resource has been purchased from a venue or location requiring parking the user of the resource or tickets may require a parking pass to enter the event. If a parking pass or other material that needs to be returned to the company/business is shipped with the resource, the DISTRIBUTION MANAGER 8020 at this point handles the follow up for that material collecting it as needed 8200. If any materials that need to be returned to the company/business by the user, such as a parking pass, are included with the package being sent, the DISTRIBUTION MANAGER 8020 has the option of generating a return shipping label to be included with the package so that the owner of the resources does not have to pay for the shipment.

There may be cases when the DISTRIBUTION MANAGER 8020 may choose to offer the resource on a first come first serve basis 8220 without concern for who uses the resource just as long as the resource is used. When a general user decides to utilize a resource on this basis the DISTRIBUTION MANAGER 8020 at any time may review who attained the resource and when. The DISTRIBUTION MANAGER 8020 may view a detailed report of what resource is going to who and when they are scheduled to receive the resource. Depending on the company/business policy, there are situations in which the resource might be needed elsewhere and this review process may be needed in those situations. If needed the distribution manager may veto the distribution of a resource 8260 given the proper rights and they may confiscate the resource for use elsewhere. If desired, the DISTRIBUTION MANAGER 8020 may issue a survey or form to a user who received a resource on a first come first serve basis and email them an interactive form to attain the information needed from them 8240.

In the event that a resource was either misused or disapproved for use, the ERM software 10 offers a failsafe allowing a DISTRIBUTION MANAGER 8020 to veto any distribution so that for whatever reason, the resource may be used in another fashion. This grants the DISTRIBUTION MANAGER 8020 significant rights when handling all inventory and it is left to the company/business to delegate responsibility and rights to their DISTRIBUTION MANAGERS 8020 to handle this function properly.

Similarly, the DISTRIBUTION MANAGER 8020 may play a larger role in handling the delegation of responsibility of inventory to certain administrators. This DISTRIBUTION MANAGER 8020 has the right to pass resources onto secondary ‘ITEM MANAGERS’ to distribute resources to a smaller group of users 8280. This ability allows the DISTRIBUTION MANAGER 8020 to remove himself/herself from choosing who receives tickets and places them in a managerial role over more secular managers. This function is a major advantage in larger companies that may have regional centers and allows the company/business to centralize the procurement process without centralizing the distribution process. Likewise the company/business may choose not to do so giving the ERM software 10 a wide range of flexibility.

In similar form, the DISTRIBUTION MANAGER 8020 may veto or remove resources at any time from the care of item managers for use in other places 8300. This process allows lateral and upward mobility when handling the distribution without having to physically move the resource around. Much like the ITEM MANAGER 4000, the DISTRIBUTION MANAGER 8020 may also have the right to view a list of allocated resources and determine where they must be sent 8320. This allows the distribution manager 8020 to take on the role of shipment and tracking if needed without having the responsibility of managing the inventory as well.

At this point, the DISTRIBUTION MANAGER 8020 may print out the labels and stuff the package with whatever materials the company/business wishes to send 8340. The package materials may also be printed from the ERM software 10 including company/business resource utilization policies or behavior policies that they wish the user to receive along with the resource. Finally, the DISTRIBUTION MANAGER 8020 may physically ship or send the resources 83.60 to the new owner for them to enjoy.

The system administrator 32 handles the upkeep and alterations for the ERM software 10 including all maintenance, updates, patches, and upgrades. The system administrator 32 has the rights to enter into a development environment with the ERM software and make changes as necessary to meet all customer and performance expectations. This person 32 may make changes to the ERM software 10 and the ERM software environment when given access rights to the platform on which the ERM software 10 is hosted.

The system administrator 32, once having access rights to ERM software 10 being used by a particular business/company, is able to make updates to the ERM software 10, and troubleshoot and fix software bugs within the ERM software 10. The system administrator may also perform upgrades to the ERM software 10 and install patches on the ERM software 10, as well as run performance analysis software against the ERM software 10 to ensure the ERM software 10 is running at customer approved standards. The system administrator 10 may also update and modify database structures and data inside the ERM software 10.

FIG. 19 illustrates a human resource manager process layout. The HUMAN RESOURCE MANAGER 9000 handles the user base of the ERM software 10, and is a vital role in keeping up with the employee base and making sure that the users that are allowed into the ERM system are ones that need to use the system. As employees change frequently at larger companies the HUMAN RESOURCE MANAGER 9000 makes sure that every employee record is kept up to date and the information that is currently in the ERM database 150 matches that company/business's employee database. The HUMAN RESOURCE MANAGER 9000 also tracks and handles any activity related to employee action such as incentives or reprimands.

The HUMAN RESOURCE MANAGER 9000 deals with the hiring and firing activities 9020 of the company/business. The scope of the ERM software 10 does not encompass this function but the user performing the role of HUMAN RESOURCE MANAGER 9000 should have some insight into the process of employee gain and loss. This way the HUMAN RESOURCE MANAGER 9000 is able to keep the ERM database 150 up to date.

The information about the user should be collected upon hiring and stored in a record 9040 somewhere at the company/business. The ERM system may have access to this ERM database 150 of employees or may not depending on the technology that is used in house. By using the user import SDK (Software Development Kit), the company/business can create a bridge between the ERM system and that of the human resources employee records to make user updates easier and more automated. The ERM software 10 also contains a bridge between the ERM system and the Active Directory structure of the company/business that links the two upon the consent of the company/business.

Each employee who enters the ERM system may be given some sort of ‘primary key’. This key should be unique to each user and may be a means to distinguish between employees 9060. The system may maintain a special record that is open to any type of unique ID that the company/business wishes to use in a proprietary format. This ID may be matched against the company/business system and the data concerning the user may be extrapolated and formatted to link the two systems together.

The company/business may be given an SDK for the ERM system that allows them to link to the ERM system in any way they wish using a standard protocol 9080. This protocol may be a web service interfacing with the ERM software 10 they are running currently to manage their employee ERM database 150. Providing this system may be an integral part of versions to ease the login process and aid in the decrease of time spent with data input. This web service may only interface between their proprietary system and the ERM software 10 given a valid license key.

Within the ERM system, if the company/business chooses to develop a bridge between the ERM software 10, the ERM software 10 may provide an option to replicate the current state of the company's human resource software database given the correct plug-in and license 9100. If the company/business does not have the option to replicate the employee or user database, employee/users are manually entered into the system and assigned specific groups and permissions to each 9120. Similarly, the user has an option to visit the web application and apply for membership to which the manager may either accept the user and a valid entry or reject the membership for whatever reason.

At any time, the manager may update or remove a user from the ERM system 9140 by editing their account information. The ERM software 10 also responds excellent to directional movement when grouping users whether it is up, down, or lateral within the organizational structure of the company/business. The manager simply needs to modify the group settings and the user gains or loses privileges depending on the transfer of rights.

The organization of a company/business is mainly based around a hierarchy 9160 and is reflected with the ERM software 10. Outside of the ERM system, the organizational structure is forged. This structure may easily be ported into the ERM software 10 and may be reflected immediately in the rights and groupings of users. The ‘Org. Chart’ is key in determining who manages whom in the world of human resources. Usually this chart is recorded and is available to most personnel for reference reasons.

The organizational structure of the company/business may be entered into the ERM system 9180 to be used as a guideline for user rights. This structure may play a vital role in determining which users may see which resources. The organization always begins with the company/business name as the root node in the tree and the organization is built from this seed. In an uncomplicated and completely unique way the HAN RESOURCE MANAGER 9000 may build the entire company/business structure from scratch and use this similar to the active directory trees that a Microsoft network utilizes.

The structure of the company/business may be modified in any way 9200. As a convenient functionality, the ERM software 10 has built in a self-healing linkage system that may automatically shift rights depending on the change that is made to the organizational chart. If a node is removed from the tree, users shift to the next level up from the deleted branch and laterally if needed when one branch is sewn onto another. At all times, the users maintain the rights that the human resource manager sets forth for them.

An employee may either behave poorly or well on the job. Many companies/businesses keep track of employee incentive and punishment on record 9220. As either good or bad reports filter in, the HUMAN RESOURCE MANAGER 9000 files them in an employee record for internal use. The ERM software 10 enables these behaviors to be either be rewarded or penalized via distribution of resources.

In the ERM system, the users may be offered rewards for good behavior and also may be penalized for bad behavior 9240. The HUMAN RESOURCE MANAGER 9000 may have the option to flag an employee for misconduct or poor performance that may affect their chances of receiving resources that may be better used with another employee. The user may also be banned or blacklisted from certain events if needed. In extreme cases, the employee may be suspended or even banned from the system. On the other hand, the employee might be offered incentives by issuing incentive codes which allow the user to access or obtain certain resources that might not have been previously open to them without the code.

Human resources are usually the department that disseminates company-wide information such as newsletters and bulletins. This information is compiled out of the system and is made ready for certain groups or mass distribution 9260. The HUMAN RESOURCE MANAGER 9000 may choose to issue a bulletin 9280 that employees may see on the general user site to relay vital information needed for day-to-day operation of the ERM software 10 or just as a daily reminder of certain events. This information may be controlled by the system administrator and may be made available on a group-to-group basis if preferred. The system also allows the HUMAN RESOURCE MANAGER 9000 to mass email the company/business with information 9300 as needed or to create groups of users similar to the contact and email groupings that Microsoft Outlook provides. These email groupings may be created manually or automatically using the organizational chart structure in the ERM software 10.

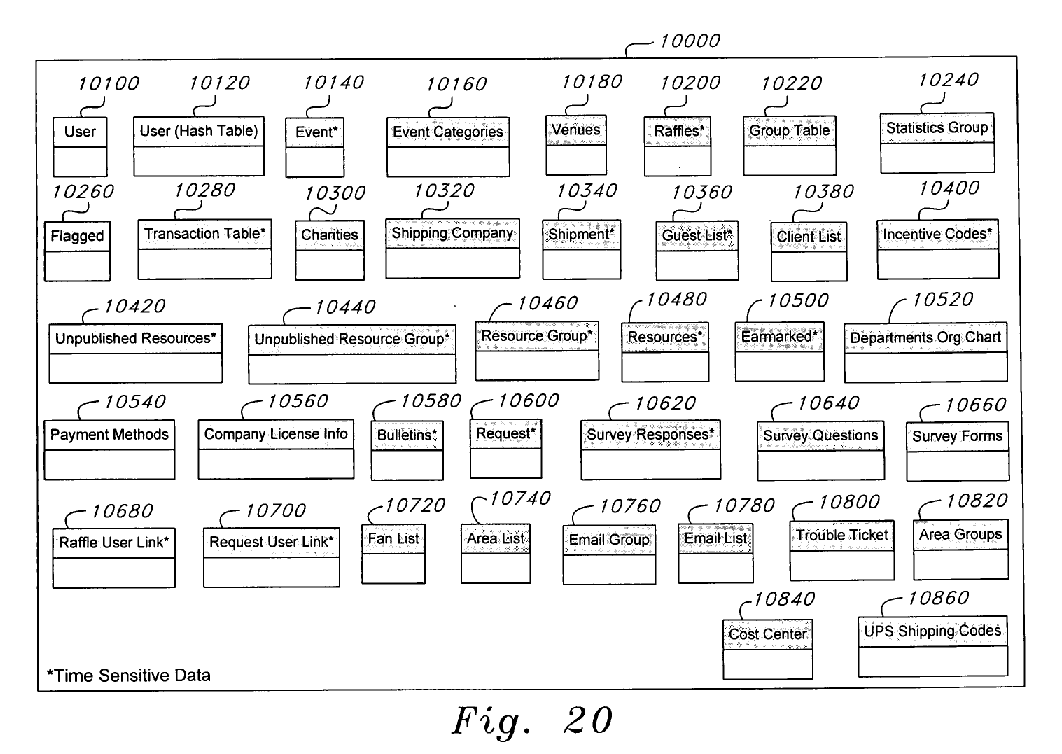

FIG. 20 illustrates the table list 10000 of the ERM database 150. The tables included in the TABLE LIST 10000 include USER 10100, USER (HASH TABLE) 10120, EVENT 10140, EVENT CATEGORIES 10160, VENUES 10180, RAFFLES 10200, GROUP TABLE 10220, STATISTICS GROUP 10240, FLAGGED 10260, TRANSACTION TABLE 10280, CHARITIES 10300, SHIPPING COMPANY 10320, SHIPMENT 10340, GUEST LIST 10360, CLIENT LIST 10380, INCENTIVE CODES 10400, UNPUBLISHED RESOURCES 10420, UNPUBLISHED RESOURCE GROUP 10440, RESOURCE GROUP 10460, RESOURCES 10480, EARMARKED 10500, DEPARTMENTS ORGANIZATIONAL CHART 10520, PAYMENT METHODS 10540, COMPANY LICENSE INFORMATION 10560, BULLETINS 10580, REQUEST 10600, SURVEY RESPONSES 10620, SURVEY QUESTIONS 10640, SURVEY FORMS 10660, RAFFLE USER LINK 10680, REQUEST USER LINK 10700, FAN LIST 10720, AREA LIST 10740, EMAIL GROUP 10760, EMAIL LIST 10780, TROUBLE TICKET 10800, AREA GROUPS 10820, COST CENTER 10840, and UPS SHIPPING CODES 10860.

The TRANSACTION TABLE 10280, SHIPMENT 10340, GUEST LIST 10360, INCENTIVE CODES 10400, UNPUBLISHED RESOURCES 10420, UNPUBLISHED RESOURCE GROUP 10440, RESOURCE GROUP 10460, RESOURCES 10480, EARMARKED 10500, BULLETINS 10580, REQUEST 10600, SURVEY RESPONSES 10620, RAFFLE USER LINK 10680, and REQUEST USER LINK 10700 tables contain time sensitive data. Time sensitive tables are ones that are looked over regularly by the ERM system and analyzed for alerts and clean up processes.

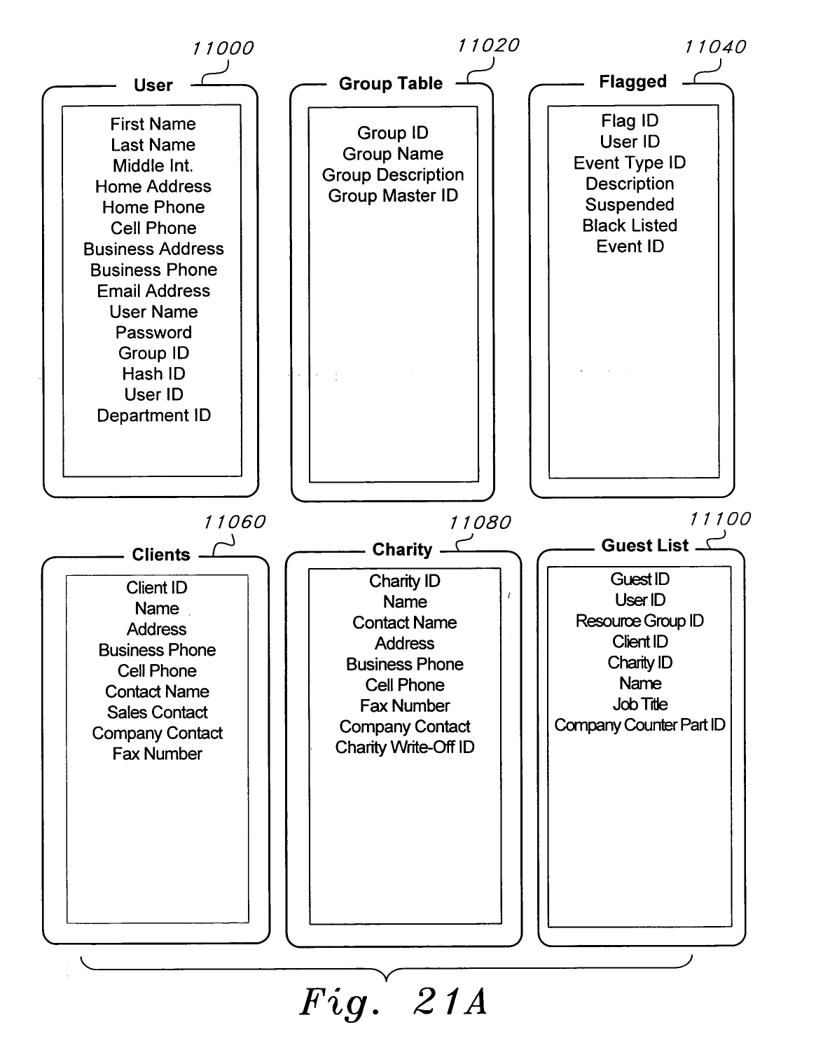

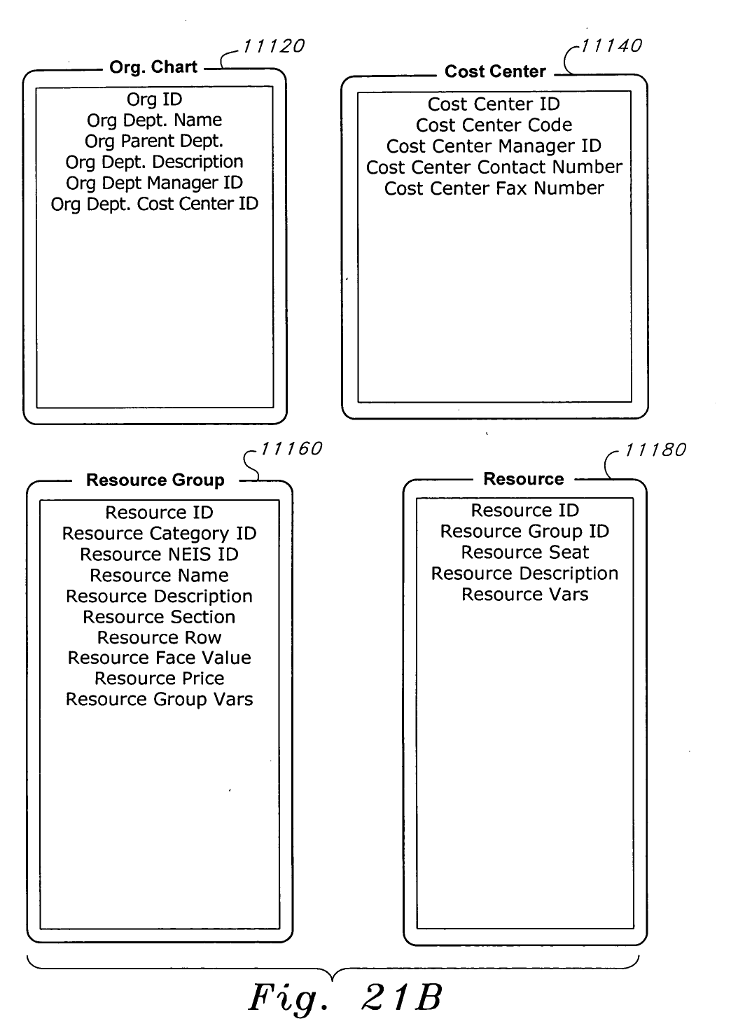

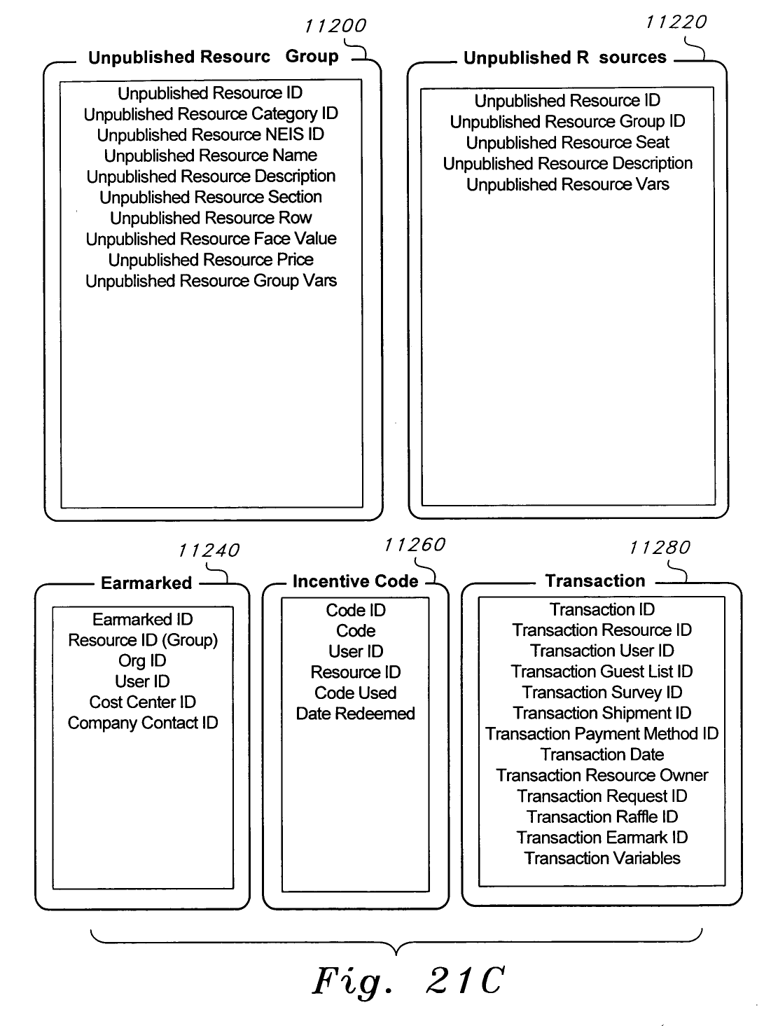

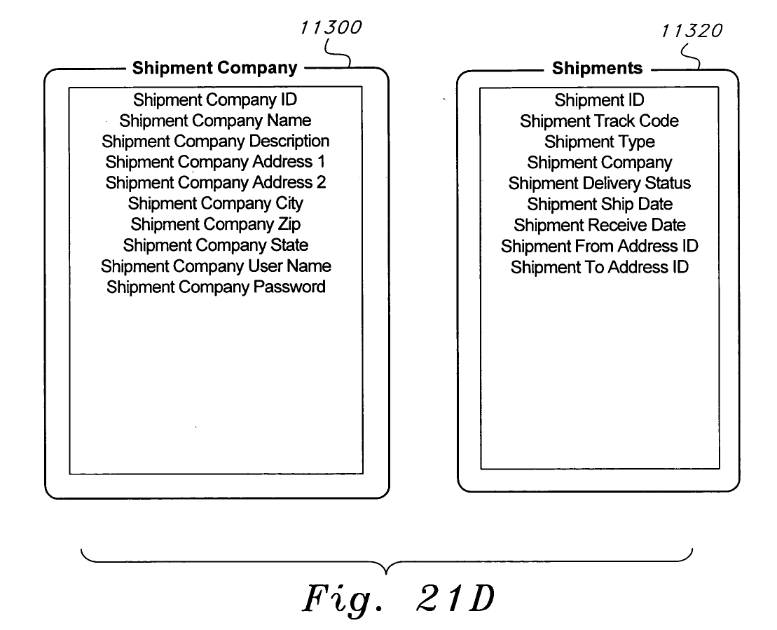

FIGS. 21A through 21D show the first set of the ERM database 150 table structures. The ERM database 150 table structure for USER 11000 includes the fields FIRST NAME, LAST NAME, MIDDLE INITIAL, HOME ADDRESS, HOME PHONE, CELL PHONE, BUSINESS ADDRESS, BUSINESS PHONE, EMAIL ADDRESS, USER NAME, PASSWORD, GROUP ID, HASH ID, USER ID, and DEPARTMENT ID. The ERM database 150 table structure for GROUP TABLE 11020 includes the fields GROUP ID, GROUP NAME, GROUP DESCRIPTION, and GROUP MASTER ID. The ERM database 150 table structure for FLAGGED 11040 includes the fields FLAG ID, USER ID, EVENT TYPE ID, DESCRIPTION, SUSPENDED, BLACK LISTED, and EVENT ID. The ERM database 150 table structure for CLIENTS 11060 includes the fields CLIENT ID, NAME, ADDRESS, BUSINESS PHONE, CELL PHONE, CELL PHONE, CONTACT NAME, SALES CONTACT, COMPANY CONTACT, and FAX NUMBER. The ERM database 150 table structure for CHARITY 11080 includes the fields CHARITY ID, NAME, CONTACT NAME, ADDRESS, BUSINESS PHONE, CELL PHONE, FAX NUMBER, COMPANY CONTACT, and CHARITY WRITE-OFF ID. The ERM database 150 table structure for GUEST LIST 11100 includes the fields GUEST ID, USER ID, RESOURCE GROUP ID, CLIENT ID, CHARITY ID, NAME, JOB TITLE, and COMPANY COUNTER PART ID.

The ERM database 150 table structure for ORGANIZATION CHART 11120 includes the fields ORGANIZATION ID, ORGANIZATION DEPARTMENT, NAME, ORGANIZATION PARENT DEPARTMENT, ORGANIZATION DEPARTMENT DESCRIPTION, ORGANIZATION DEPARTMENT MANAGER ID, and ORGANIZATION DEPARTMENT COST CENTER ID. The ERM database 150 table structure for COST CENTER 11140 includes the fields COST CENTER ID, COST CENTER CODE, COST CENTER MANAGER ID, COST CENTER CONTACT NUMBER, and COST CENTER FAX NUMBER. The ERM database 150 table structure for RESOURCE GROUP 11160 includes the fields RESOURCE ID, RESOURCE CATEGORY ID, _RESOURCE NEIS ID, RESOURCE NAME, RESOURCE DESCRIPTION, RESOURCE SECTION, RESOURCE ROW, RESOURCE FACE VALUE, RESOURCE PRICES, and RESOURCE GROUP VARS. The ERM database 150 table structure for RESOURCE 11180 includes the fields RESOURCE ID, RESOURCE GROUP ID, RESOURCE SEAT, RESOURCE DESCRIPTION, and RESOURCE VARS.

The ERM database 150 table structure for UNPUBLISHED RESOURCE GROUP 11200 includes the fields UNPUBLISHED RESOURCE ID, UNPUBLISHED RESOURCE CATEGORY ID, UNPUBLISHED RESOURCE NEIS ID, UNPUBLISHED RESOURCE NAME, UNPUBLISHED RESOURCE DESCRIPTION, UNPUBLISHED RESOURCE SECTION, UNPUBLISHED ROW, UNPUBLISHED RESOURCE FACE VALUE, UNPUBLISHED RESOURCE PRICE, and UNPUBLISHED RESOURCE GROUP VARS. The ERM database 150 table structure for UNPUBLISHED RESOURCES 11220 includes the fields UNPUBLISHED RESOURCE ID, UNPUBLISHED RESOURCE GROUP ID, UNPUBLISHED RESOURCE SEAT, UNPUBLISHED RESOURCE DESCRIPTION, and UNPUBLISHED RESOURCE VARS. The ERM database 150 table structure for EARMARKED 11240 includes the fields EARMARKED ID, RESOURCE ID (GROUP) , ORGANIZATION ID, USER ID, COST CENTER ID, and COMPANY CONTACT ID. The ERM database 150 table structure for INCENTIVE CODE 11260 includes the fields CODE ID, CODE, USER ID, RESOURCE ID, CODE USED, and DATE REDEEMED. The ERM database 150 table structure for TRANSACTION 11280 includes the fields TRANSACTION ID, TRANSACTION RESOURCE ID, TRANSACTION USER ID, TRANSACTION GUEST LIST ID, TRANSACTION SURVEY ID, TRANSACTION SHIPMENT ID, TRANSACTION PAYMENT METHOD ID, TRANSACTION DATE, TRANSACTION RESOURCE OWNER, TRANSACTION REQUEST ID, TRANSACTION RAFFLE ID, TRANSACTION EARMARK ID, and TRANSACTION VARIABLES.

The ERM database 150 table structure for SHIPMENT COMPANY 11300 includes the fields SHIPMENT COMPANY ID, SHIPMENT COMPANY NAME, SHIPMENT COMPANY DESCRIPTION, SHIPMENT COMPANY ADDRESS 1, SHIPMENT COMPANY ADDRESS 2, SHIPMENT COMPANY CITY, SHIPMENT COMPANY STATE, SHIPMENT COMPANY USER NAME, and SHIPMENT COMPANY PASSWORD. The ERM database 150 table structure for SHIPMENTS 11320 includes the fields SHIPMENT ID, SHIPMENT TRACK CODE, SHIPMENT TYPE, SHIPMENT COMPANY, SHIPMENT DELIVERY STATUS, SHIPMENT SHIP DATE, SHIPMENT RECEIVE DATA, SHIPMENT FROM ADDRESS ID, and SHIPMENT TO ADDRESS ID.

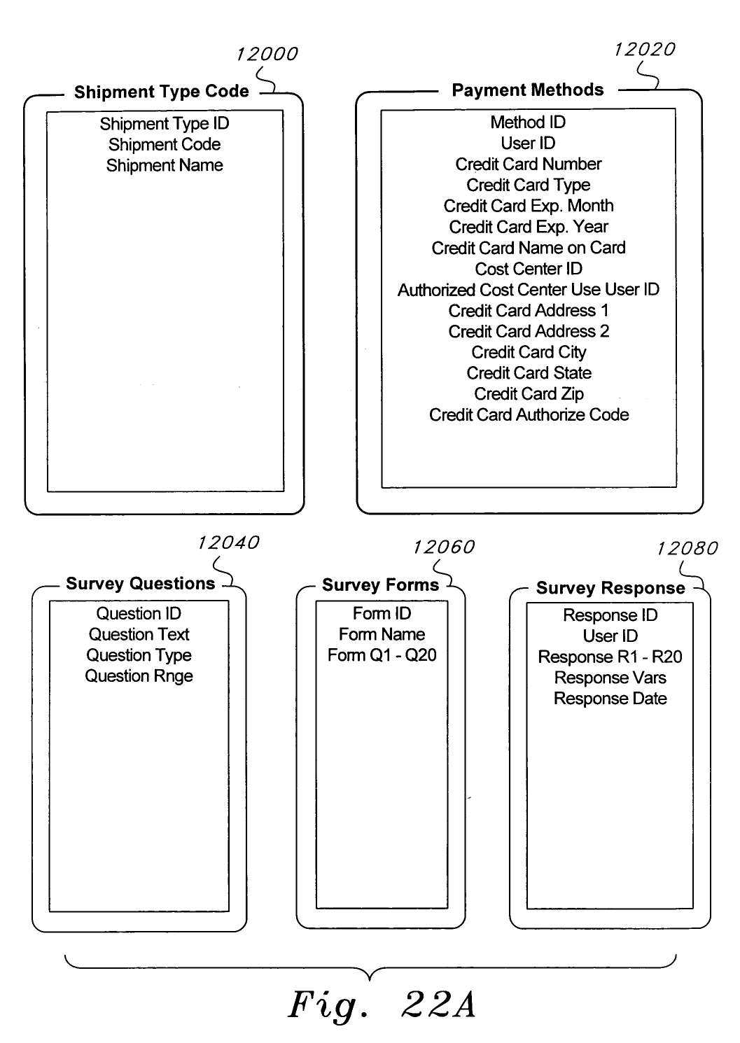

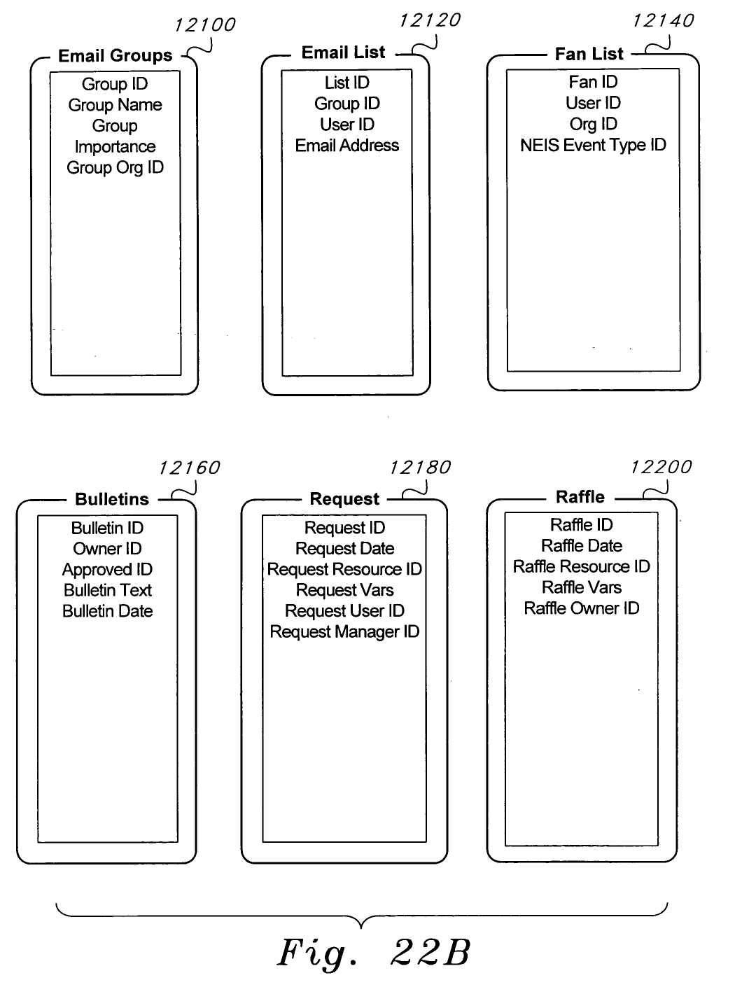

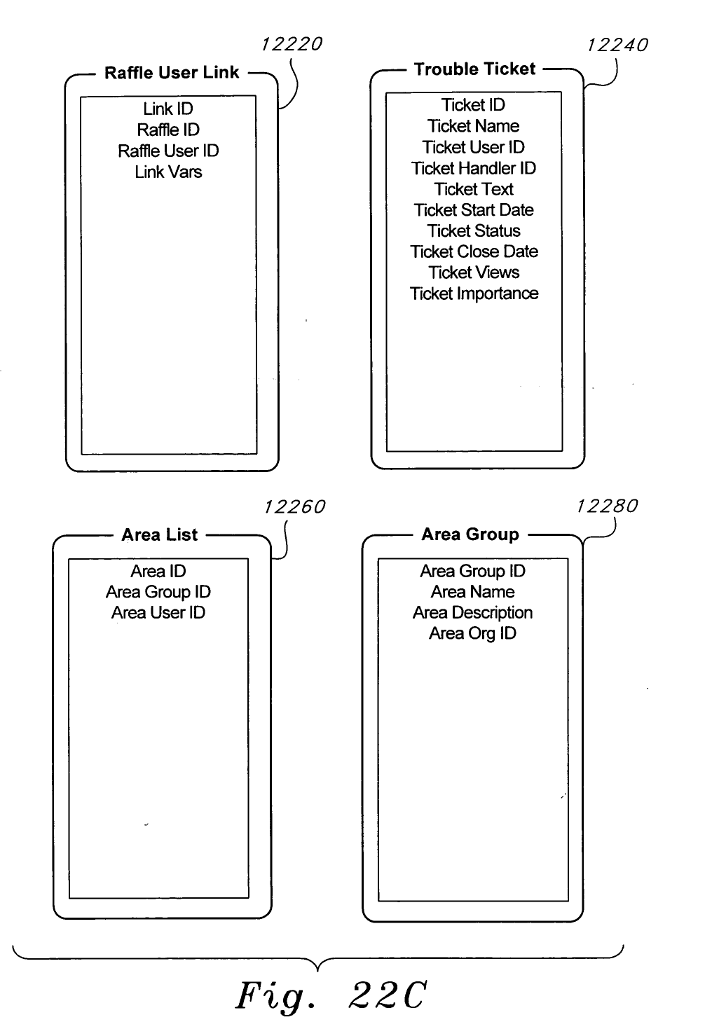

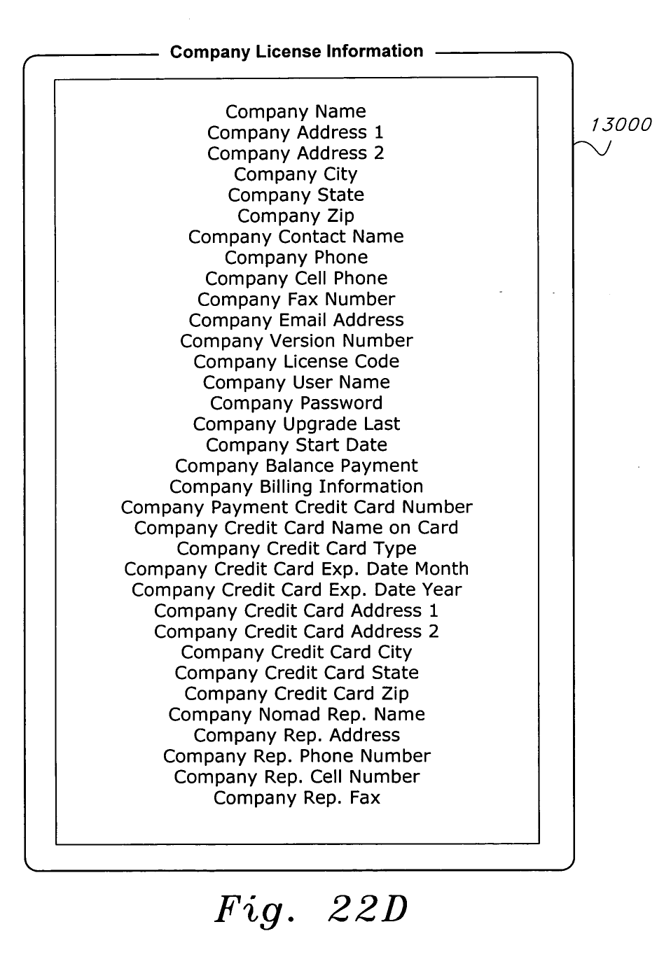

FIGS. 22A through 22D show a second set of ERM database 150 table structures. The ERM database 150 table structure for SHIPMENT TYPE CODE 12000 includes the fields SHIPMENT TYPE ID, SHIPMENT CODE, and SHIPMENT NAME. The ERM database 150 table structure for PAYMENT METHODS 12020 includes the fields METHOD ID, USER ID, CREDIT CARD NUMBER, CREDIT CARD TYPE, CREDIT CARD EXPIRATION MONTH, CREDIT CARD EXPIRATION YEAR, CREDIT CARD NAME ON CARD, COST CENTER ID, AUTHORIZED COST CENTER USE USER ID, CREDIT CARD ADDRESS 1, CREDIT CARD ADDRESS 2, CREDIT CARD CITY, CREDIT CARD STATE, CREDIT CARD ZIP, and CREDIT CARD AUTHORIZE CODE. The ERM database 150 table structures for SURVEY QUESTIONS 12040 includes the fields QUESTION ID, QUESTION TEXT, QUESTION TYPE, and QUESTION RANGE. The ERM database 150 table structure for SURVEY FORMS 12060 includes the fields FORM ID, FORM NAME, and FORM Q1-Q20. The second set of database table structures for SURVEY RESPONSE 12080 includes RESPONSE ID, USER ID, RESPONSE R1-R20, 10 RESPONSE VARS, and RESPONSE DATE.

The ERM database 150 table structure for EMAIL GROUPS 12100 includes the fields GROUP ID, GROUP NAME, GROUP, IMPORTANCE, AND GROUP ORGANIZATION ID. The ERM database 150 table structure for EMAIL LIST includes the fields LIST ID, GROUP ID, USER ID, and EMAIL ADDRESS. The ERM database 150 table structure for FAN LIST 12140 includes the fields FAN ID, USER ID, ORGANIZATION ID, and NEIS EVENT TYPE ID. The ERM database 150 table structure for BULLETINS 12160 includes the fields BULLETIN ID, OWNER ID, APPROVED ID, BULLETIN TEXT, and BULLETIN DATE. The ERM database 150 table structure for REQUEST 12180 includes the fields REQUEST ID, REQUEST DATE, REQUEST RESOURCE ID, REQUEST VARS, REQUEST USER ID, and REQUEST MANAGER ID. The ERM database 150 table structure for RAFFLE 12200 includes the fields RAFFLE ID, RAFFLE DATE, RAFFLE RESOURCE, ID, RAFFLE VARS, and RAFFLE OWNER ID.

The ERM database 150 table structure for RAFFLE USER LINK 12220 includes the fields LINK ID, RAFFLE ID, RAFFLE USER ID, and LINK VARS. The ERM database 150 table structure for TROUBLE TICKET 12240 includes the fields TICKET ID, TICKET NAME, TICKET USER ID, TICKET HANDLER ID, TICKET TEXT, TICKET START DATE, TICKET STATUS, TICKET CLOSE DATE, TICKET VIEWS, and TICKET IMPORTANCE. The ERM database 150 table structure for AREA LIST 12260 includes the fields AREA ID, AREA GROUP ID, and AREA USER ID. The ERM database 150 table structure for AREA GROUP 12280 includes the fields AREA GROUP ID, AREA NAME, AREA DESCRIPTION, and AREA ORGANIZATION ID.

The ERM database 150 table structure for COMPANY LICENSE INFORMATION 13000 includes the fields COMPANY NAME, COMPANY ADDRESS 1, COMPANY ADDRESS 2, COMPANY CITY, COMPANY STATE, COMPANY ZIP, COMPANY CONTACT NAME, COMPANY PHONE, COMPANY CELL PHONE, COMPANY FAX NUMBER, COMPANY EMAIL ADDRESS, COMPANY VERSION NUMBER, COMPANY LICENSE CODE, COMPANY USER NAME, COMPANY PASSWORD, COMPANY UPGRADE LAST, COMPANY START DATE, COMPANY BALANCE PAYMENT, COMPANY BILLING INFORMATION, COMPANY BILLING INFORMATION, COMPANY PAYMENT CREDIT CARD NUMBER, COMPANY CREDIT CARD NAME ON CARD, COMPANY CREDIT CARD TYPE, COMPANY CREDIT CARD EXPIRATION DATE MONTH, COMPANY CREDIT CARD EXPIRATION DATE YEAR, COMPANY CREDIT CARD ADDRESS 1, COMPANY CREDIT CARD ADDRESS 2, COMPANY CREDIT CARD CITY, COMPANY CREDIT CARD STATE, COMPANY CREDIT CARD ZIP, COMPANY REPRESENTATIVE NAME, COMPANY REPRESENTATIVE ADDRESS, COMPANY REPRESENTATIVE CELL NUMBER, and COMPANY REPRESENTATIVE FAX.

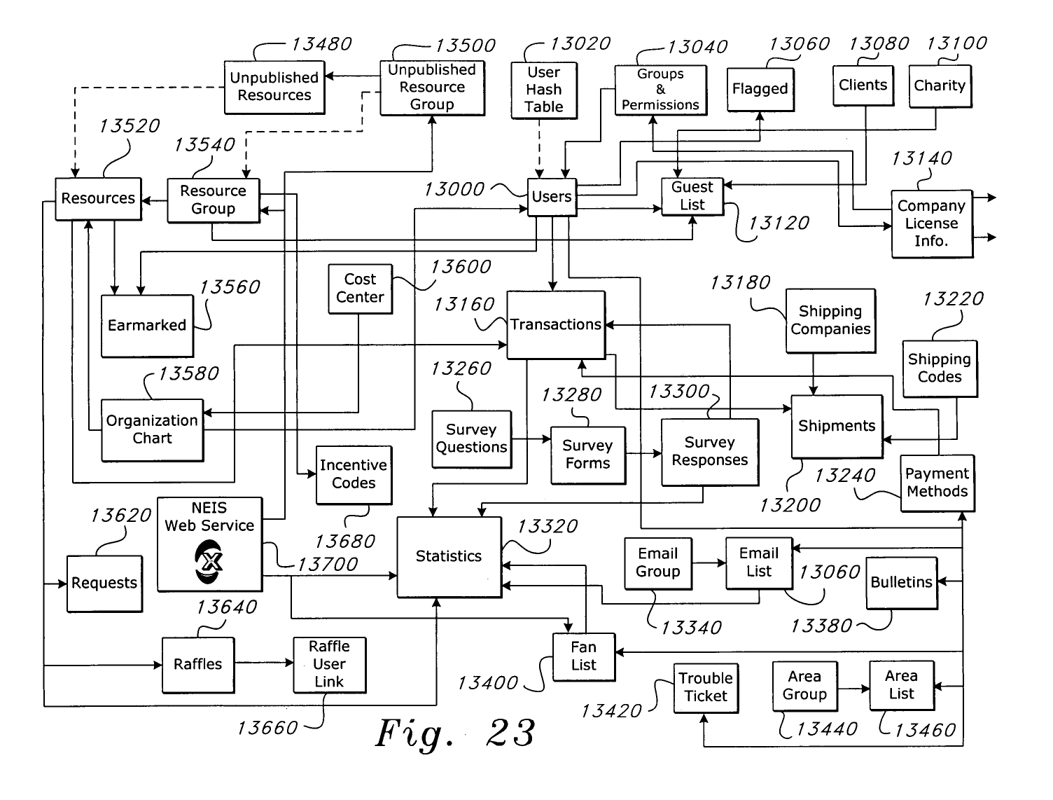

FIG. 23 illustrates a relational database flowchart associated with the ERM software 10 and ERM database 150. The flowchart shows the interaction between USERS 13000, USER HASH TABLE 13020, GROUPS AND PERMISSIONS 13040, FLAGGED 13060, CLIENTS 13080, CHARITY 13100, GUEST LIST 13120, COMPANY LICENSE INFORMATION 13140, TRANSACTIONS 13160, SHIPPING COMPANIES 13180, SHIPMENTS 13200, SHIPPING CODES 13220, PAYMENT METHODS 13240, SURVEY QUESTIONS 13260, SURVEY FORMS 13280, SURVEY RESPONSES 13300, STATISTICS 13320, EMAIL GROUP 13340, EMAIL LIST 13360, BULLETINS 13380, FAN LIST 13400, TROUBLE TICKET 13420, AREA GROUP 13440, AREA LIST 13460, UNPUBLISHED RESOURCES 13480, UNPUBLISHED RESOURCE GROUP 13500, RESOURCES 13520, RESOURCE GROUP 13540, EARMARKED 13560, ORGANIZATION CHART 13580, COST CENTER 13600, REQUESTS 13620, INCENTIVE CODES 13680, and NEIS WEB SERVICE 13700.

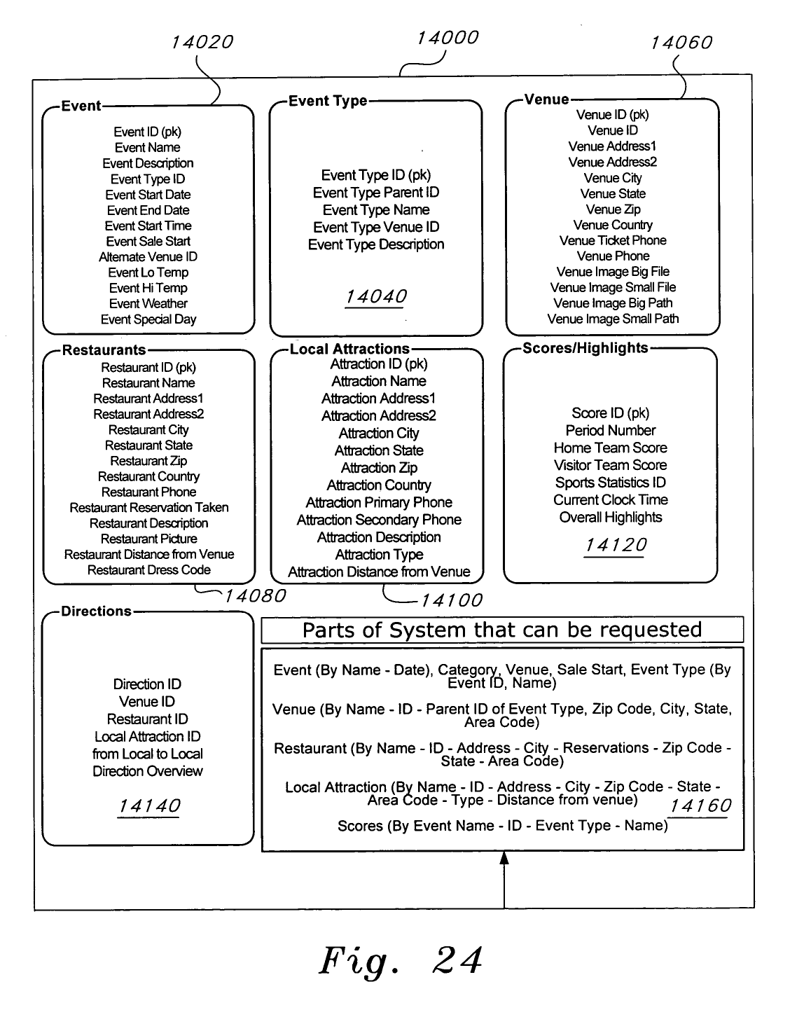

FIG. 24 illustrates the NEIS database 14000. The NEIS database includes an EVENT TABLE 14020, an EVENT TYPE TABLE 14040, a VENUE TABLE 14060, a RESTAURANTS TABLE 14080, a LOCAL ATTRACTIONS TABLE 14100, a SCORES/HIGHLIGHTS TABLE 14120, a DIRECTIONS TABLES 14140, and parts of the NEIS database that can be requested 14160. The EVENT TABLE 14020 includes EVENT ID (PK), EVENT NAME, EVENT DESCRIPTION, EVENT TYPE ID, EVENT START DATE, EVENT END DATE, EVENT START TIME, EVENT SALE START, ALTERNATE VENUE ID, EVENT LO TEMPERATURE, EVENT HI TEMPERATURE, EVENT WEATHER, and EVENT SPECIAL DAY. The EVENT TYPE TABLE 14040 includes the fields EVENT TYPE ID, EVENT TYPE PARENT ID, EVENT TYPE NAME, EVENT TYPE VENUE, and EVENT TYPE DESCRIPTION. The VENUE TABLE 14060 includes the fields VENUE ID (PK) , VENUE ID, VENUE ADDRESS 1, VENUE ADDRESS 2, VENUE CITY, VENUE STATE, VENUE ZIP, VENUE COUNTRY, VENUE TICKET PHONE, VENUE PHONE, VENUE IMAGE BIG FILE, VENUE IMAGE SMALL FILE, VENUE IMAGE BIG PATH, and VENUE IMAGE SMALL PATH. The RESTAURANTS TABLE 14080 includes the fields RESTAURANT ID (PK) , RESTAURANT NAME, RESTAURANT ADDRESS 1, RESTAURANT ADDRESS 2, RESTAURANT CITY, RESTAURANT STATE, RESTAURANT ZIP, RESTAURANT COUNTRY, RESTAURANT PHONE, RESTAURANT RESERVATION TAKEN, RESTAURANT DESCRIPTION, RESTAURANT PICTURE, RESTAURANT DISTANCE FROM VENUE, and RESTAURANT DRESS CODE.

The LOCAL ATTRACTIONS TABLE 14100 includes the fields ATTRACTION ID (PK) , ATTRACTION ADDRESS 1, ATTRACTION ADDRESS 2, ATTRACTION CITY, ATTRACTION STATE, ATTRACTION ZIP, ATTRACTION COUNTRY, ATTRACTION PRIMARY PHONE, ATTRACTION SECONDARY PHONE, ATTRACTION DESCRIPTION, ATTRACTION TYPE, and ATTRACTION DISTANCE FROM VENUE. The SCORES/HIGHLIGHTS TABLE 14120 includes the fields SCORE ID (PK) , PERIOD NUMBER, HOME TEAM SCORE, VISITOR TEAM SCORE, SPORTS STATISTICS ID, CURRENT CLOCK TIME, and OVERALL HIGHLIGHTS. The DIRECTIONS TABLE 14140 includes the fields DIRECTION ID, VENUE ID, RESTAURANT ID, LOCAL ATTRACTION ID, FROM LOCAL TO LOCAL, and DIRECTION OVERVIEW. Parts of the system that can be requested 14160 include fields: EVENT (by name-date) , CATEGORY, VENUE, SALE START, EVENT TYPE (by event ID, name); VENUE (by name-ID-parent Id of event type, zip code, city, state, area code); RESTAURANT (by name-ID-address-city-reservations-reservations-zip code-state-area code); LOCAL ATTRACTION (by name-ID-address-city-zip code-state-area code-type-distance from venue); and SCORES (by event name-ID-event type-name).

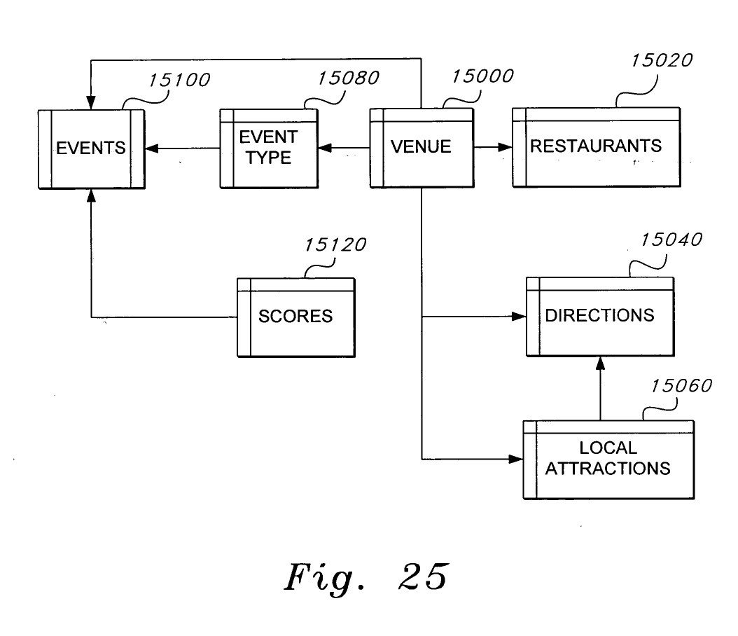

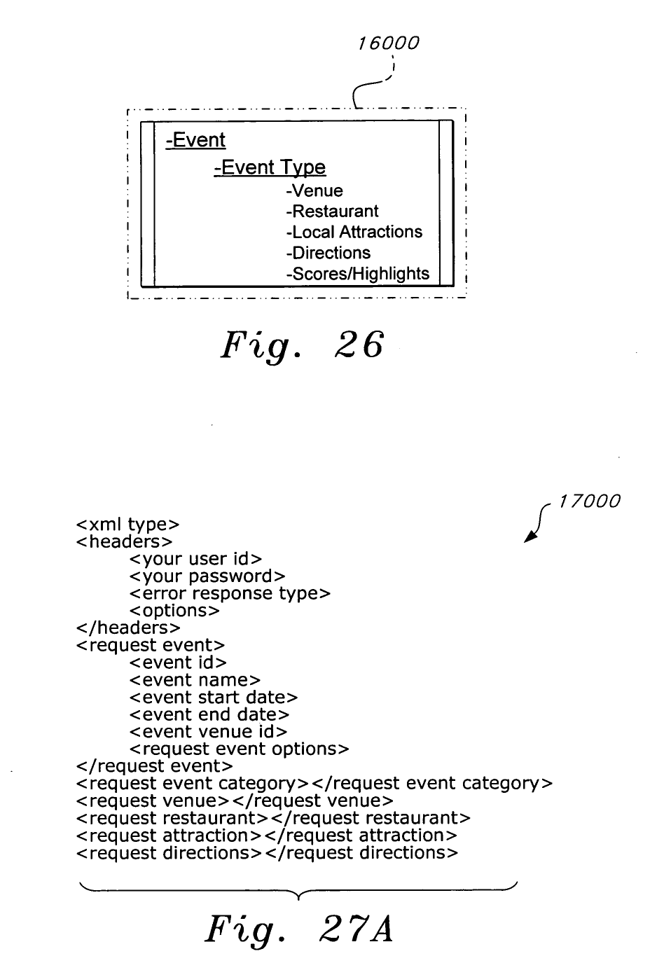

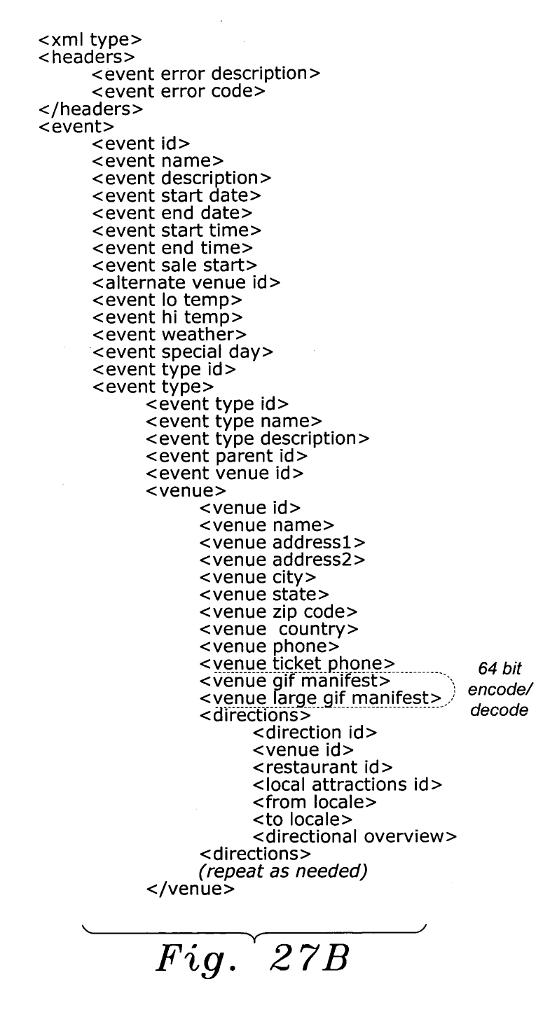

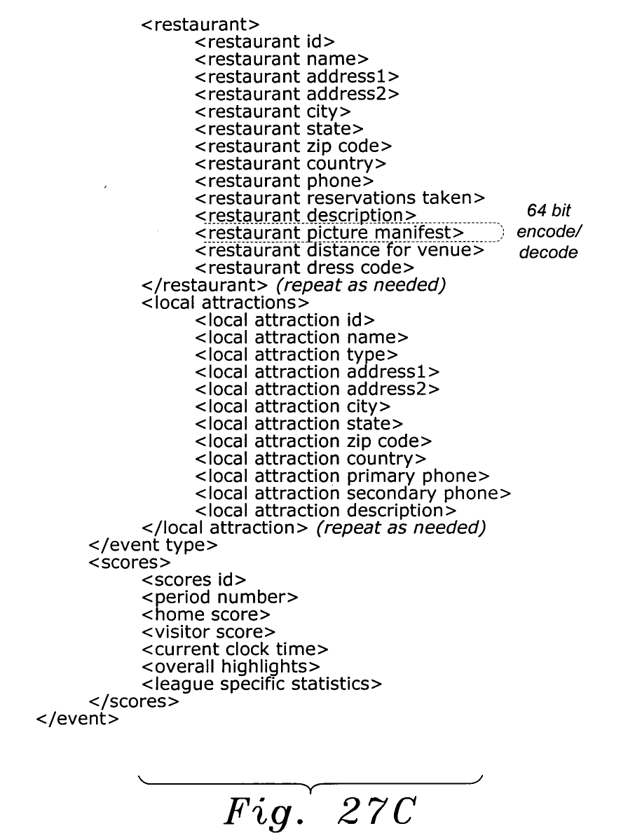

FIG. 25 illustrates an NEIS flowchart diagram and the interaction between the fields VENUE 15000, RESTAURANTS 15020, DIRECTIONS 15040, LOCAL ATTRACTIONS 15060, EVENT TYPE 15080, EVENTS 15100, and SCORES 15120. FIG. 26 shows a basic XML structure 16000 for the NEIS according to the invention. FIGS. 27A, 27B, and 27C show a basic XML structure 17000 for the NEIS that may be used with ERM software 10 according to the present invention.

Several configurations of ERM software 10 according to the invention that vary in the amount of available functionality may be provided to the general public. For example, a first configuration of the ERM software 10 may provide the least functionality. Such a configuration may only provide the basic capability needed by a resource manager in a company. This configuration may store all of the company's resources in one place and only enable a user to enter inventory into the ERM system. It may only offer an option for any authorized management to enter the ERM software 10 and view the inventory in the system along with a scaled down version of the reporting software. The reporting functionality may be limited to tracking what is entered into the system or the quantity and stock of specific events and resources. The first configuration of the ERM software 10 may include a central database, full NEIS access, Internet Access, limited reporting and management information systems, educational materials, and basic customer support.

A second configuration of the ERM software 10 may include all functionality from the first configuration of the ERM software 10. The second configuration of the ERM software 10 enables a user to create a work group structure and define branches and divisions in the company/business. Allowing an administrator to utilize a work group business model offers the ability to define a company/business structure and use the organization to speak directly with these groups. The second configuration enables the administrator to email each group about resources but does not offer the ability to distribute or resell to anyone. The second configuration of the ERM software 10 may include a central database, full NEIS access, Internet Access, limited reporting and management information systems, preference tracking, user company/business workgroups, user database, email communications, educational materials, and customer support.

A third configuration of the ERM software 10 includes a larger variety of functionality. The third configuration includes some type of distribution built into the ERM software 10. At this point, the company/business needs access to payment and shipping solutions over the Internet and may start to utilize a to-scale version of the reporting and management information systems features of the system. The third configuration of the ERM software 10 may also introduce the general user website enabling the user base to access software of its own. In the first and second configurations of the ERM software 10, the inventory is communicated via administrative software or email. However, the distribution is limited only to resale within the company/business to allow the company/business to make money back from unused resources. These resources are also limited to the events that are offered from the NEIS system ingrained in the ERM software 10.

Another unique feature that may be added to the third configuration of the ERM software 10 is the introduction of the action alert system. This special piece of software runs as a separate window that displays a real-time table of what actions need to be taken within the system listing them from the most critical to the least critical. Each item is linked directly to the action that needs to be taken. The third configuration of the ERM software 10 includes a central database, full NEIS access, Internet Access, reporting and management information systems, preference tracking, user company/business workgroups, user database, email communications, internal resale database, general user software, online payment solutions, online shipping solutions, administrative workgroups, action alert system, educational materials, and expanded customer support.

A fourth configuration of the ERM software 10 may include every feature in the third configuration with a dynamic expansion added to the system. The fourth configuration may include every feature that the ERM software 10 has to offer with the exception of reselling resources to external business on the business resale network. The fourth configuration includes the entire distribution, reporting, survey, internal resale, communications, workgroup, and administrative packages allowing the user to control every aspect of their internal resources. The fourth configuration includes the highest level of customer support and an SDK for companies/businesses that wish to push the ERM software 10 above and beyond its limit.

The company/business may enter special company/business specific events outside of the NEIS system and enter resources into the ERM software 10 under those categories. The fourth configuration of the ERM software 10 includes a central database, full NEIS access, Internet Access, reporting and management information systems, responsive survey/form database, preference tracking, user company/business workgroups, user database, full email/Internet communications, internal resale database, general user software, online payment solutions, online shipping solutions, administrative workgroups, action alert system, full distribution pipeline, SDK for software expansion, educational materials and classes, and premier customer support.

A fifth configuration of the ERM software 10 may vary slightly from the fourth configuration of the ERM software 10. The fifth configuration includes every feature in the fourth configuration as well as a license to resell any resource in their inventory over the Internet on a central sight dedicated to business-to-business direct resale of internal company/business resources. This ‘Business Resale Network’ allows the company/business to offload or pickup any resources needed that other companies have to offer. The fifth configuration of the ERM software 10 includes a central database, full NEIS access, Internet Access, reporting and management information systems, responsive survey/form database, preference tracking, user company/business workgroups, user database, full email/Internet communications, internal resale database, general user software, online payment solutions, online shipping solutions, administrative workgroups, action alert system, full distribution pipeline, SDK for software expansion, business resale network license, educational materials and classes, and premier customer support.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A method for enterprise resource management (ERM), said method comprising:
executing ERM software for managing internal resources of a company/business in an ERM system;
selectively authorizing users associated with the company/business based on grouping designations of the users to access internal resource data about the company/business via the ERM software and an ERM database; and
managing, distributing, tracking, organizing, analyzing, and storing internal resource data via the ERM software.

2. An enterprise resource management (ERM) system, said system comprising:
a computer useable medium; and
a computer device having a processor;
wherein said computer useable medium carries thereon ERM software, which, when executed by the processor, causes the processor to carry out steps comprising:
executing ERM software for managing internal resources of a company/business in an ERM system;
selectively authorizing users associated with the company/business based on grouping designations of the users to access internal resource data about the company/business via the ERM software and an ERM database; and
managing, distributing, tracking, organizing, analyzing, and storing internal resource data via the ERM software.

3. A computer useable medium carrying enterprise resource management (ERM) software which, when executed by a processor, causes the processor to carry out steps comprising:
executing ERM software for managing internal resources of a company/business in an ERM system;
selectively authorizing users associated with the company/business based on grouping designations of the users to access internal resource data about the company/business via the ERM software and an ERM database; and
managing, distributing, tracking, organizing, analyzing, and storing internal resource data via the ERM software.

4. The computer useable medium according to claim 3, wherein said ERM software, when executed by the processor, further causes the processor to carry out steps comprising:
establishing administrator ERM software restrictively accessible by only qualified administrators; and
establishing general user ERM software accessible by general users.

5. The computer useable medium according to claim 4, wherein said ERM software, when executed by the processor, further causes the processor to carry out steps comprising:
manually adding a new user into the ERM database;
updating user information for a particular user and making any desired changes to profile information for the particular user;
flagging a particular user by marking profile information for the particular user in a predetermined manner;
viewing applications from users desiring to become a member of the ERM system for the company/business;
verifying profiles of applicants seeking membership into the ERM system for the company/business;
viewing a distribution group of a particular user;
assigning a manager to a distribution group;
grouping users into specific categories;
adding a parent or child grouping to an organizational chart of a distribution group;
viewing properties of an organizational distribution group;
modifying an existing distribution group; and
changing a grouping structure regarding a position of a distribution group.

6. The computer useable medium according to claim 3, wherein said establishing general user ERM software step further comprises:
accepting general user personal information entered into form fields;
creating a general user login account and an application for acceptance by a general user;
validating an application by a general user for acceptance into the ERM system;
granting acceptance for a general user into the ERM system;
denying acceptance for a general user into the ERM system;
enabling an accepted general user in the ERM system to view ERM resources;
enabling an accepted general user in the ERM system to request ERM resources from the company/business;
enabling an accepted general user in the ERM system to obtain ERM resources from the company/business; and
enabling an accepted general user in the ERM system to buy ERM resources from the company/business.

7. The computer useable medium according to claim 3, wherein said managing, distributing, tracking, organizing, analyzing, and storing internal resource data step further comprises:
obtaining resources for the ERM system of the company/business;
managing obtained resources;
distributing obtained resources to users of the ERM system of the company/business;
tracking distributed resources;
organizing obtained resources;
analyzing obtained resources; and
storing internal resource data for obtained resources.

8. The computer useable medium according to claim 7, wherein said distributing obtained resources step further comprises:
raffling resources;
providing resources on a first come first serve basis;
reselling resources;
providing resources to a business network;
providing resources to charitable giveaways;
earmarking resources; and
freely providing resources.

9. The computer useable medium according to claim 8, wherein said raffling resources step further comprises:
enabling users to apply for a resource being raffled in a raffle;
manually adding users into the raffle before the raffle is run;
canceling the raffle for the resource;
determining a winner for the resource being raffled; and
notifying the winner regarding winning a resource being raffled.

10. The computer useable medium according to claim 8, wherein said providing resources on a first come first serve basis step further comprises:
offering a resource to users on a first come first serve basis;
obtaining a request from a particular user for the offered resource;
reviewing the particular user and the offered resource;
determining whether to provide the particular user with the offered resource;
providing the offered resource to the particular user if a corresponding determination is made;
retaining the offered resource to the particular user if a corresponding determination is made; and
providing a survey/form to the particular user if the offered resource is provided.

11. The computer useable medium according to claim 8, wherein said reselling resources step further comprises:
placing a resource up for resale to users in a particular system where the users may buy them; and
tracking a resource after the resource is sold to a particular user.

12. The computer useable medium according to claim 8, wherein said providing resources to a business network step further comprises:
providing a resource in a business network; and
tracking the resource after the resource is provided to the business network.

13. The computer useable medium according to claim 8, wherein said providing resources to charitable giveaways step further comprises:
offering a resource to charitable giveaways;
obtaining a request from a particular charitable giveaway for the offered resource; and
providing the offered resource to the particular charitable giveaway.

14. The computer useable medium according to claim 8, wherein said earmarking resources step further comprises:
determining a suitability of a particular user to have access to an earmarked resource;
determining whether to provide the earmarked resource to the particular user or one other than the particular user;
notifying the particular user they will receive the earmarked resource if a corresponding determination is made;
providing the earmarked resource to the particular user if a corresponding determination is made; and
providing the earmarked resource to one other than the particular user if a corresponding determination is made.

15. The computer useable medium according to claim 8, wherein said freely providing resources step further comprises:
freely offering a resource to users;
determining a suitability of a particular user to have access to the free resource;
notifying the particular user they will receive the free resource if a corresponding determination is made;
providing the free resource to the particular user if a corresponding determination is made.

16. The computer useable medium according to claim 3, wherein said executing ERM software for managing internal resources of a company/business in an ERM system step further comprises:
providing inventory processes;
providing distribution processes;
providing reporting processes;
providing maintenance processes;
providing upgrading processes;
providing user management processes;
providing help and tutorial processes; and providing user communication and interaction processes.

17. The computer useable medium according to claim 16, wherein said providing inventory processes step further comprises:
providing an inventory landing page;
adding inventory the ERM database;
providing a resource identification to inventory added to the ERM database;
grouping inventory added to the ERM database; and
earmarking inventory added to the ERM database;
attaching inventory added to the ERM database to an event/resource category.
displaying inventory attached to an event/category category;
modifying a resource or group of resources from the ERM database; and
deleting a resource or group of resources from the ERM database.

18. The computer useable medium according to claim 16, wherein said providing distribution processes step further comprises:
providing a DISTRIBUTION LANDING page;
providing a TABLE OF ITEMS page;
providing a CALENDAR OF ITEMS page;
providing a CATEGORY SEARCH page;
providing a TYPE SEARCH page;
providing a RULES page; and
providing a TAKE ACTION OFF RULES PAGE RESULTS DISPLAYED page.

19. The computer useable medium according to claim 16, wherein said providing reporting processes step further comprises:
providing surveys/forms to users;
receiving surveys/forms from users;
reviewing surveys/forms received from users;
storing data regarding surveys/forms received from users;
obtaining quantitative/qualitative information from stored data regarding surveys/forms received from users; and
providing reports for the company/business.

20. The computer useable medium according to claim 16, wherein said providing maintenance processes step further comprises:
providing a MAINTENANCE AND SUPPORT LANDING page; and
providing a SUPPORT CONTACT INFORMATION page.

21. The computer useable medium according to claim 16, wherein said providing upgrading processes step further comprises:
providing a purchase and/or install upgrade page;
enabling the company/business to purchase new upgrades or software for the ERM software; and
enabling the company/business to install upgrades locally.

22. The computer useable medium according to claim 16, wherein said providing user management processes step further comprises:
providing an ADMINISTRATIVE APPLICATION SUPPORT SYSTEM page; and
providing a TROUBLE TICKET SYSTEM page

23. The computer useable medium according to claim 16, wherein said providing help and tutorial processes step further comprises:
providing a SEARCH HELP TOPICS page;
providing SEARCH INDEX OF HELP TOPICS page;
providing a SUPPORT CONTACT INFORMATION page;
providing a FREQUENTLY ASKED QUESTIONS (FAQ) CHART page; and
providing an ONLINE TUTORIALS page.

24. The computer useable medium according to claim 16, wherein said providing user communication and interaction processes step further comprises:
providing COMMUNICATION LANDING page;
providing a BULLETIN BOARD LIST page;
providing a VIEW BULLETIN BOARD ITEM page;
providing an ADD BULLETIN BOARD ITEM page;
providing an UPDATE BULLETIN BOARD LIST page;
providing an APPROVE/DISAPPROVE BULLETIN page; and
providing a PUBLISH BULLETIN BOARD ITEM page.

25. The computer useable medium according to claim 3, wherein said selectively authorizing users step further comprises:
accepting general user personal information entered into form fields;
creating a general user login account and an application for acceptance by a general user;
validating an application by a general user for acceptance into the ERM system;
granting acceptance for a general user into the ERM system; and
denying acceptance for a general user into the ERM system enabling an accepted general user in the ERM system to view ERM resources;
enabling an accepted general user in the ERM system to request ERM resources from the company/business;
enabling an accepted general user in the ERM system to obtain ERM resources from the company/business;
enabling an accepted general user in the ERM system to buy ERM resources from the company/business;
connecting to an Active Directory (AD) structure of the company/business;
obtaining information from the AD structure of the company/business Active Directory (AD) structure of the company/business; and
linking and replicating a user database of the company/business with the ERM database using a Software Development Kit (SDK).

26. The computer useable medium according to claim 3, wherein said executing ERM software step further comprises:
creating shipping labels using third party software;
shipping a resource to a new owner; and
tracking the shipped resource using third party tracking functions.

27. The computer useable medium according to claim 3, wherein said executing ERM software step further comprises:
providing online payment and resale capability using third party software.

28. The computer useable medium according to claim 3, wherein said executing ERM software step further comprises:
providing an online alert application for linking to the ERM software to notify administrators of upcoming tasks and resources for action.

29. The computer useable medium according to claim 3, wherein said executing ERM software step further comprises:
producing a report that measures the usage of inventory and resources;
providing a GETSMART ANALYSIS TOOL for offering suggestions on management decisions regarding data in the ERM database; and
producing dynamic graphs and charts regarding data in the ERM database.

30. The computer useable medium according to claim 3, wherein said managing, distributing, tracking, organizing, analyzing, and storing internal resource data via the ERM software step further comprises:
providing inventory/schedule manager processes;
providing distribution manager processes;
providing site administrator processes;
providing system administrator processes; and
providing site assistant administrator processes;
providing report manager processes;
providing item manager processes;
providing human resource processes; and
providing general user processes.

31. The computer useable medium according to claim 30, wherein said providing inventory/schedule manager processes step further comprises:
procuring inventory based on statistics from the previous and current year;
reviewing archived data to calculate trends and demands;
analyzing current clients and targeting sales of the company/business to find out what kind of return can be made on specific resources;
reviewing patterns and tracking records of sales teams to determine how to optimize response from clients regarding business entertainment; and
providing links to outside resource(s) to assist users in making inventory decisions.

32. The computer useable medium according to claim 3, wherein said providing distribution manager processes step further comprises:
trafficking resources for the company/business;
distributing resources; and
using, selling, or giving away inventory resources at particular times.

33. The computer useable medium according to claim 30, wherein said providing site administrator processes step further comprises:
updating account information for the company/business in the ERM system;
configuring the ERM system for upgrading via the Internet;
authorizing any work to be done to the ERM system;
calling/placing a trouble ticket with a developer of the ERM software if the ERM software is not properly operating;
obtaining immediate service from the developer of the ERM software.

34. The computer useable medium according to claim 30, wherein said providing system administrator processes step further comprises:
making updates to the ERM software;
troubleshooting and fixing software bugs within the ERM software;
performing upgrades to the ERM software;
installing patches on the ERM software;
running performance analysis software against the ERM software to ensure the ERM software is running at customer approved standards; and
updating and modifying database structures and data inside the ERM software.

35. The computer useable medium according to claim 30, wherein said providing site assistant administrator processes step further comprises:
utilizing temporary rights to fulfill roles of a distribution manager and an inventory manager until a site administrator returns.

36. The computer useable medium according to claim 30, wherein said report manager step further comprises providing surveys/forms to users;
receiving surveys/forms from users;
reviewing surveys/forms received from users;
storing data regarding surveys/forms received from users;
obtaining quantitative/qualitative information from stored data regarding surveys/forms received from users; and
providing reports for the company/business.

37. The computer useable medium according to claim 30 wherein said providing human resources manager processes step further comprises:
manually adding a new user into the ERM database;
updating user information for a particular user and making any desired changes to profile information for the particular user;
flagging a particular user by marking profile information for the particular user in a predetermined manner;
viewing applications from users desiring to become a member of the ERM system for the company/business;
verifying profiles of applicants seeking membership into the ERM system for the company/business;
viewing a distribution group of a particular user;
assigning a manager to a distribution group;
grouping users into specific categories;
adding a parent or child grouping to an organizational chart of a distribution group;
viewing properties of an organizational distribution group;
modifying an existing distribution group; and
changing a grouping structure regarding a position of a distribution group.

38. The computer useable medium according to claim 30, wherein said providing general user processes step further comprises:
viewing resources within the ERM system that are available to a particular general user;
searching through an inventory of the ERM system for a particular resource;
applying for the particular resource;
selecting a shipment method to obtain the particular resource; and
paying for the particular resource using third party software.

39. Enterprise resource management (ERM) software for managing internal resources of a company/business, the ERM software being stored on a computer useable medium, and being configured in the form of first ERM software, second ERM software, third ERM software, fourth ERM software, and fifth ERM software.

40. The ERM software according to claim 39, wherein said first ERM software, when executed by a processor, causes the processor to carry out steps comprising:
storing all resources of a company in one place;
enabling only a single user to enter inventory into an ERM database of an ERM system;
tracking inventory entries into the ERM system or the quantity and stock of specific events and resources;
accessing a central database;
accessing a National Event Index Service;
accessing the Internet; and
utilizing reporting and management information systems, educational materials, and basic customer support in a limited manner.

41. The ERM software according to claim 39, wherein said second ERM software, when executed by a processor, causes the processor to carry out steps comprising:
storing all resources of a company in one place;
enabling only a single user to enter inventory into an ERM database of an ERM system;
creating a work group structure and defining branches and divisions in a company/business;
enabling an administrator of the company/business to email groups about company/business resources;
tracking inventory entries into the ERM system or the quantity and stock of specific events and resources;
accessing a central database;
accessing a National Event Index Service;
accessing the Internet; and
utilizing reporting and management information systems, educational materials, and standard customer support in a limited manner.

42. The ERM software according to claim 39, wherein said third ERM software, when executed by a processor, causes the processor to carry out steps comprising:
storing all resources of a company in one place;
enabling only a single user to enter the enter inventory into an ERM database of an ERM system;
creating a work group structure and defining branches and divisions in a company/business;
enabling an administrator of the company/business to email groups about company/business resources;
tracking inventory entries into the ERM system or the quantity and stock of specific events and resources;
accessing a central database;
accessing a National Event Index Service;
accessing the Internet for payment and shipping solutions;
providing a website for general users and enabling the general users to access general user ERM software from the website; and
utilizing reporting and management information systems, educational materials, and premier customer support.

43. The ERM software according to claim 39, wherein said fourth ERM software, when executed by a processor, causes the processor to carry out steps comprising:
storing resources of a company;
enabling users to enter inventory into an ERM database of an ERM system;
creating a work group structure and defining branches and divisions in a company/business;
enabling an administrator of the company/business to email groups about company/business resources;
tracking inventory entries into the ERM system or the quantity and stock of specific events and resources;
accessing a central database;
accessing a National Event Index Service;
accessing the Internet for payment and shipping solutions;
providing a website for general users and enabling the general users to access general user ERM software from the website;
utilizing reporting and management information systems, educational materials, and premier customer support; and
providing an action alert system to display a real-time table of actions to be taken within the ERM system listing them from most critical to least critical.

44. The ERM software according to claim 39, wherein said fifth ERM software, when executed by a processor, causes the processor to carry out steps comprising:
storing resources of a company;
enabling users to enter the enter inventory into an ERM database of an ERM system;
creating a work group structure and defining branches and divisions in a company/business;
enabling an administrator of the company/business to email groups about company/business resources;
tracking inventory entries into the ERM system or the quantity and stock of specific events and resources;
accessing a central database;
accessing a National Event Index Service;
accessing the Internet for payment and shipping solutions;
providing a website for general users and enabling the general users to access general user ERM software from the website;
utilizing reporting and management information systems, educational materials, and basic customer support in a limited manner;
providing an action alert system to display a real-time table of actions to be taken within the ERM system listing them from most critical to least critical; and
reselling resources to an external business on a business resale network.

45. The ERM software according to claim 39, wherein said fifth ERM software, when executed by a processor, causes the processor to carry out steps comprising:
storing resources of a company;
enabling users to enter the enter inventory into an ERM database of an ERM system;
creating a work group structure and defining branches and divisions in a company/business;
enabling an administrator of the company/business to email groups about company/business resources;
tracking inventory entries into the ERM system or the quantity and stock of specific events and resources;
accessing a central database;
accessing a National Event Index Service;
accessing the Internet for payment and shipping solutions;
providing a website for general users and enabling the general users to access general user ERM software from the website;
utilizing reporting and management information systems, educational materials, and basic customer support in a limited manner;
providing an action alert system to display a real-time table of actions to be taken within the ERM system listing them from most critical to least critical;
reselling resources to an external business on a business resale network; and
reselling any resource in the inventory of the company/business over the Internet on a central sight dedicated to business-to-business direct resale of internal company/business resources via a license.

46. A National Event Index Service (NEIS) comprising: a database including an EVENT TABLE; an EVENT TYPE TABLE; a VENUE TABLE; a RESTAURANTS TABLE; a LOCAL ATTRACTIONS TABLE; a SCORES/HIGHLIGHTS TABLE; and DIRECTIONS TABLES.

47. The NEIS according to claim 46, wherein interaction occurs between fields of the EVENT TABLE, EVENT TYPE TABLE, VENUE TABLE, RESTAURANTS TABLE, LOCAL ATTRACTIONS TABLE, SCORES/HIGHLIGHTS TABLE, and DIRECTIONS TABLES.

48. The NEIS according to claim 46, wherein said EVENT TABLE includes the fields EVENT ID (PK), EVENT NAME, EVENT DESCRIPTION, EVENT TYPE ID, EVENT START DATE, EVENT END DATE, EVENT START TIME, EVENT SALE START, ALTERNATE VENUE ID, EVENT LO TEMPERATURE, EVENT HI TEMPERATURE, EVENT WEATHER, and EVENT SPECIAL DAY.

49. The NEIS according to claim 46, wherein said EVENT TYPE TABLE includes the fields EVENT TYPE ID, EVENT TYPE PARENT ID, EVENT TYPE NAME, EVENT TYPE VENUE, and EVENT TYPE DESCRIPTION.

50. The NEIS according to claim 46, wherein said VENUE TYPE TABLE includes the fields VENUE ID (PK) , VENUE ID, VENUE ADDRESS 1, VENUE ADDRESS 2, VENUE CITY, VENUE STATE, VENUE ZIP, VENUE COUNTRY, VENUE TICKET PHONE, VENUE PHONE, VENUE IMAGE BIG FILE, VENUE IMAGE SMALL FILE, VENUE IMAGE BIG PATH, and VENUE IMAGE SMALL PATH.

51. The NEIS according to claim 46, wherein said RESTAURANTS TABLE includes the fields RESTAURANT ID (PK) , RESTAURANT NAME, RESTAURANT ADDRESS 1, RESTAURANT ADDRESS 2, RESTAURANT CITY, RESTAURANT STATE, RESTAURANT ZIP, RESTAURANT COUNTRY, RESTAURANT PHONE, RESTAURANT RESERVATION TAKEN, RESTAURANT DESCRIPTION, RESTAURANT PICTURE, RESTAURANT DISTANCE FROM VENUE, and RESTAURANT DRESS CODE.

52. The NEIS according to claim 46, wherein said LOCAL ATTRACTIONS TABLE includes the fields ATTRACTION ID (PK), ATTRACTION ADDRESS 1, ATTRACTION ADDRESS 2, ATTRACTION CITY, ATTRACTION STATE, ATTRACTION ZIP, ATTRACTION COUNTRY, ATTRACTION PRIMARY PHONE, ATTRACTION SECONDARY PHONE, ATTRACTION DESCRIPTION, ATTRACTION TYPE, and ATTRACTION DISTANCE FROM VENUE.

53. The NEIS according to claim 46, wherein said SCORES/HIGHLIGHTS TABLE includes the fields SCORE ID (PK), PERIOD NUMBER, HOME TEAM SCORE, VISITOR TEAM SCORE, SPORTS STATISTICS ID, CURRENT CLOCK TIME, and OVERALL HIGHLIGHTS.

54. The NEIS according to claim 46, wherein said DIRECTIONS TABLE includes the fields DIRECTION ID, VENUE ID, RESTAURANT ID, LOCAL ATTRACTION ID, FROM LOCAL TO LOCAL, and DIRECTION OVERVIEW.

55. The NEIS according to claim 46, further comprising a tracking tool for providing feedback to the NEIS regarding data access by users.

56. The NEIS according to claim 46, further comprising providing means for requesting events from the database over the Internet.

57. The NEIS according to claim 46, further comprising means for executing lookup calls on events based on names and identifications.
